(19) United States
(12) Patent Application Publication
(10) Pub. No.: US 2018/0375215 A1
(43) Pub. Date: Dec. 27, 2018

(54) ELECTROMAGNETIC WAVE ABSORPTION MATERIAL, ELECTROMAGNETIC WAVE ABSORBER, AND PRODUCTION METHODS THEREFOR

(71) Applicant: ZEON CORPORATION, Chiyoda-ku Tokyo (JP)

(72) Inventors: Tsutomu NAGAMUNE, Chiyoda-ku, Tokyo (JP); Yoshihisa TAKEYAMA, Chiyoda-ku, Tokyo (JP)

(73) Assignee: ZEON CORPORATION, Chiyoda-ku Tokyo (JP)

(21) Appl. No.: 16/061,720

(22) PCT Filed: Dec. 22, 2016
(86) PCT No.: PCT/JP2016/088552

§ 371 Date: Jun. 13, 2018

(30) Foreign Application Priority Data
Dec. 25, 2015 (JP) 2015-255343

(51) Int. Cl. H01Q 17/00; C01B 32/159; C01B 32/168

(52) U.S. Cl. CPC H01Q 17/00; C01B 32/159; C01B 32/168; C01P 2006/12; C01P 2004/64; B82Y 30/00; C01B 2202/32; C01B 2202/36; C01B 2202/02; C01B 2202/06; C01P 2004/133

(57) ABSTRACT

An electromagnetic wave absorption material comprises surface-treated fibrous carbon nanostructures obtainable by treating surfaces of fibrous carbon nanostructures, wherein at surfaces of the surface-treated fibrous carbon nanostructures, an amount of an oxygen element is 0.030 times or more and 0.300 times or less an amount of a carbon element and/or an amount of a nitrogen element is 0.005 times or more and 0.200 times or less the amount of the carbon element.

### TECHNICAL FIELD

The present disclosure relates to an electromagnetic wave absorption material, an electromagnetic wave absorber, and production methods therefor.

### BACKGROUND

It has been conventionally known to use materials containing conductive materials as electromagnetic wave absorption materials in fields of electricity, communication, etc. In these fields, the use frequency differs depending on the intended use. In actual use environments, an electromagnetic wave of a frequency domain other than a required frequency domain often occurs as noise. This has created the demand for an electromagnetic wave absorption material capable of attenuating an electromagnetic wave of an unwanted frequency without attenuating an electromagnetic wave of a required frequency.

For example, a noise suppressor that contains a conductive material and is capable of attenuating an electromagnetic wave of a relatively high frequency domain without attenuating an electromagnetic wave of a low frequency domain has been proposed (for example, see JP 2010-87372 A (PTL 1)). Moreover, an electromagnetic wave absorption material that contains a conductive material and is capable of absorbing an electromagnetic wave of a frequency domain of 1 GHz or more has been proposed (for example, see JP 2003-158395 A (PTL 2)).

### CITATION LIST

### Patent Literatures

PTL 1: JP 2010-87372 A

PTL 2: JP 2003-158395 A

### SUMMARY

### Technical Problem

In recent years, frequencies of electromagnetic waves used in various application fields have been shifted toward higher frequency domains, and the need for an electromagnetic wave absorption material capable of absorbing an electromagnetic wave of a higher frequency has been growing. However, absorption capacity for an electromagnetic wave of a higher frequency domain has not been specifically addressed by the noise suppressor in PTL 1 or the electromagnetic wave absorption material in PTL 2, and its effects have been entirely unknown.

It could therefore be helpful to provide an electromagnetic wave absorption material capable of absorbing an electromagnetic wave of a high frequency domain, an electromagnetic wave absorber including an electromagnetic wave absorption layer made of the electromagnetic wave absorption material, and production methods therefor,

### Solution to Problem

The inventors conducted extensive studies to solve the problems stated above. The inventors particularly focused on fibrous carbon nanostructures from among many conductive materials, as an electromagnetic wave absorption material. The inventors newly discovered that, by containing, in an electromagnetic wave absorption material, a fibrous carbon nanomaterial whose proportion of the oxygen element and/or the nitrogen element to the carbon element at surfaces of fibrous carbon nanostructures is in a specific range, the electromagnetic wave absorption capacity of the resultant electromagnetic wave absorption material in a high frequency domain of more than 20 GHz can be enhanced sufficiently.

To advantageously solve the problems stated above, a presently disclosed electromagnetic wave absorption material is an electromagnetic wave absorption material comprising surface-treated fibrous carbon nanostructures obtainable by treating surfaces of fibrous carbon nanostructures, wherein at surfaces of the surface-treated fibrous carbon nanostructures, an amount of an oxygen element is 0.030 times or more and 0.300 times or less an amount of a carbon element and/or an amount of a nitrogen element is 0.005 times or more and 0.200 times or less the amount of the carbon element. By limiting the content of the nitrogen element and/or the oxygen element at the surfaces of the surface-treated fibrous carbon nanostructures to the above-mentioned specific range, the absorption capacity of the electromagnetic wave absorption material for an electromagnetic wave of a high frequency domain of more than 20 GHz can be enhanced sufficiently.

Preferably, in the presently disclosed electromagnetic wave absorption material, at the surfaces of the surface-treated fibrous carbon nanostructures, the amount of the oxygen element is 0.030 times or more and 0.300 times or less the amount of the carbon element and the amount of the nitrogen element is 0.005 times or more and 0.200 times or less the amount of the carbon element. By limiting the content of each of the nitrogen element and the oxygen element at the surfaces of the surface-treated fibrous carbon nanostructures to the above-mentioned specific range, the absorption capacity of the electromagnetic wave absorption material for an electromagnetic wave of a high frequency domain of more than 20 GHz can be further enhanced.

Preferably, in the presently disclosed electromagnetic wave absorption material, a BET specific surface area of the fibrous carbon nanostructures is 200 m²/g or more. With the surface-treated fibrous carbon nanostructures obtained using the fibrous carbon nanostructures having a BET specific surface area of 200 m²/g or more, the electromagnetic wave absorption capacity of the electromagnetic wave absorption material in a high frequency domain can be further enhanced.

Preferably, in the presently disclosed electromagnetic wave absorption material, a t-plot of the fibrous carbon nanostructures is convex upward. With the surface-treated fibrous carbon nanostructures obtained using the fibrous carbon nanostructures having a convex upward t-plot, the electromagnetic wave absorption capacity of the electromagnetic wave absorption material in a high frequency domain can be further enhanced.

Preferably, in the presently disclosed electromagnetic wave absorption material, a number average diameter of the fibrous carbon nanostructures is 15 nm or less. With the surface-treated fibrous carbon nanostructures obtained using the fibrous carbon nanostructures having a number average diameter of 15 nm or less, the flexibility of the electromagnetic wave absorption material can be improved.

Preferably, in the presently disclosed electromagnetic wave absorption material, the fibrous carbon nanostructures include single-walled carbon nanotubes and multi-walled carbon nanotubes, and a content of the single-walled carbon nanotubes is 50 mass % or more in the case where a whole content of the fibrous carbon nanostructures is 100 mass %. With the surface-treated fibrous carbon nanostructures obtained using the fibrous carbon nanostructures having a single-walled carbon nanotube content of 50 mass % or more, the electromagnetic wave absorption efficiency of the electromagnetic wave absorption material can be improved.

Preferably, the presently disclosed electromagnetic wave absorption material further comprises an insulating material, wherein a content A of the surface-treated fibrous carbon nanostructures is 0.5 parts by mass or more and 15 parts by mass or less in the case where a content of the insulating material is 100 parts by mass. By limiting the content A to this range, the electromagnetic wave absorption capacity of the electromagnetic wave absorption material in a high frequency domain can be further improved.

Preferably, in the presently disclosed electromagnetic wave absorption material, the insulating material is insulating resin. In this way, the balance between flexibility and durability of the electromagnetic wave absorption material can be improved.

To advantageously solve the problems stated above, a presently disclosed electromagnetic wave absorber is an electromagnetic wave absorber comprising an electromagnetic wave absorption layer formed using the electromagnetic wave absorption material described above. Such an electromagnetic wave absorber has excellent electromagnetic wave absorption capacity in a high frequency domain of more than 20 GHz.

To advantageously solve the problems stated above, a presently disclosed electromagnetic wave absorber is an electromagnetic wave absorber comprising a plurality of electromagnetic wave absorption layers each including surface-treated fibrous carbon nanostructures and an insulating material, wherein surface-treated fibrous carbon nanostructures and/or insulating materials included in the respective plurality of electromagnetic wave absorption layers are of a same type or different types, in the case where the plurality of electromagnetic wave absorption layers are denoted as a first electromagnetic wave absorption layer, a second electromagnetic wave absorption layer, . . . , and an nth electromagnetic wave absorption layer from a side farther from an electromagnetic wave incidence side and contents of the surface-treated fibrous carbon nanostructures in the respective plurality of electromagnetic wave absorption layers are denoted as A1 parts by mass, A2 parts by mass, . . . , and An parts by mass where a content of the insulating material in a corresponding electromagnetic wave absorption layer is 100 parts by mass, the following formulas (1) and any of (2) and (3) hold true:

0.5≤A1≤15 (1)

A1>A2, when n is 2 (2)

A1>A2≥ . . . ≥An, when n is a natural number of 3 or more (3),

the first electromagnetic wave absorption layer from among all of the plurality of electromagnetic wave absorption layers has a highest content of surface-treated fibrous carbon nanostructures, and at surfaces of the surface-treated fibrous carbon nanostructures, an amount of an oxygen element is 0.030 times or more and 0.300 times or less an amount of a carbon element and/or an amount of a nitrogen element is 0.005 times or more and 0.200 times or less the amount of the carbon element. The electromagnetic wave absorber having such a structure has excellent electromagnetic wave absorption capacity in a high frequency domain of more than 20 GHz.

Preferably, in the presently disclosed electromagnetic wave absorber, at the surfaces of the surface-treated fibrous carbon nanostructures, the amount of the oxygen element is 0.030 times or more and 0.300 times or less the amount of the carbon element and the amount of the nitrogen element is 0.005 times or more and 0.200 times or less the amount of the carbon element. By limiting the content of the nitrogen element and the oxygen element at the surfaces of the surface-treated fibrous carbon nanostructures to the above-mentioned specific range, the absorption capacity for an electromagnetic wave of a high frequency domain of more than 20 GHz can be enhanced sufficiently.

Preferably, the presently disclosed electromagnetic wave absorber further comprises an insulating layer at an outermost surface on the electromagnetic wave incidence side. Such an electromagnetic wave absorber has better electromagnetic wave absorption capacity in a high frequency domain of more than 20 GHz, and has excellent durability.

To advantageously solve the problems stated above, a presently disclosed production method for an electromagnetic wave absorption material is a production method for an electromagnetic wave absorption material, comprising a surface treatment step of treating surfaces of fibrous carbon nanostructures with plasma and/or ozone, to obtain surface-treated fibrous carbon nanostructures at surfaces of which an amount of an oxygen element is 0.030 times or more and 0.300 times or less an amount of a carbon element and/or an amount of a nitrogen element is 0.005 times or more and 0.200 times or less the amount of the carbon element. By containing the surface-treated fibrous carbon nanostructures with the content of the nitrogen element and/or the oxygen element at the surfaces being in the above-mentioned specific range, an electromagnetic wave absorption material having sufficiently high absorption capacity for an electromagnetic wave of a high frequency domain of more than 20 GHz can be obtained.

To advantageously solve the problems stated above, a presently disclosed production method for an electromagnetic wave absorption material is a production method for an electromagnetic wave absorption material, comprising a surface treatment step of treating surfaces of fibrous carbon nanostructures with plasma, to obtain surface-treated fibrous carbon nanostructures at surfaces of which an amount of a nitrogen element is 0.005 times or more and 0.200 times or less an amount of a carbon element. By containing the surface-treated fibrous carbon nanostructures with the nitrogen element at the surfaces being in the above-mentioned specific range, an electromagnetic wave absorption material having sufficiently high absorption capacity for an electromagnetic wave of a high frequency domain of more than 20 GHz can be obtained.

To advantageously solve the problems stated above, a presently disclosed production method for an electromagnetic wave absorber is a production method for an electromagnetic wave absorber, comprising: a step of mixing surface-treated fibrous carbon nanostructures obtained in the surface treatment step described above and an insulating material, to obtain a mixture; and a step of shaping the mixture to obtain an electromagnetic wave absorber. By containing the fibrous carbon nanostructures satisfying the above-mentioned properties, an electromagnetic wave absorber having sufficiently high absorption capacity for an electromagnetic wave of a high frequency domain of more than 20 GHz can be obtained.

### Advantageous Effect

It is therefore possible to provide an electromagnetic wave absorption material and an electromagnetic wave absorber capable of absorbing an electromagnetic wave of a high frequency domain of more than 20 GHz, and production methods therefor.

### DETAILED DESCRIPTION

One of the disclosed embodiments is described in detail below.

A presently disclosed electromagnetic wave absorption material and electromagnetic wave absorber contain surface-treated fibrous carbon nanostructures and an insulating material, and may be used in next-generation wireless LANs, automotive radar braking systems, optical transmission devices, and microwave communication equipment, without being limited thereto. The presently disclosed electromagnetic wave absorption material and electromagnetic wave absorber have excellent electromagnetic wave absorption capacity in a high frequency domain of more than 20 GHz.

(Electromagnetic Wave Absorption Material)

The presently disclosed electromagnetic wave absorption material contains surface-treated fibrous carbon nanostructures obtainable by treating surfaces of fibrous carbon nanostructures. It is necessary that, at the surfaces of the surface-treated fibrous carbon nanostructures, the amount of the oxygen element is 0.030 times or more and 0.300 times or less the amount of the carbon element and/or the amount of the nitrogen element is 0.005 times or more and 0.200 times or less the amount of the carbon element. With the presently disclosed electromagnetic wave absorption material, typically, an electromagnetic wave of a high frequency domain of more than 20 GHz can be absorbed.

Regarding electromagnetic wave absorption of a composite material containing fibrous carbon nanostructures, the following points are commonly known. When a composite material containing fibrous carbon nanostructures is irradiated with an electromagnetic wave, the electromagnetic wave is repeatedly reflected between the fibrous carbon nanostructures in the composite material, and the electromagnetic wave attenuates. Moreover, when the fibrous carbon nanostructures reflect the electromagnetic wave, the fibrous carbon nanostructures absorb the electromagnetic wave and convert it into heat. The inventors conducted further studies, and newly discovered that the electromagnetic wave absorption capacity in a high frequency domain can be considerably improved by limiting the amount of the oxygen element and/or the nitrogen element at the surfaces of the fibrous carbon nanostructures to the above-mentioned specific range.

<Fibrous Carbon Nanostructures>

### —Surface Characteristics of Surface-Treated Fibrous Carbon Nanostructures—

It is necessary that, at the surfaces of the surface-treated fibrous carbon nanostructures obtainable by treating the surfaces of the fibrous carbon nanostructures, the amount of the oxygen element is 0.030 times or more and 0.300 times or less the amount of the carbon element and/or the amount of the nitrogen element is 0.005 times or more and 0.200 times or less the amount of the carbon element. The amount of the oxygen element is preferably 0.080 times or more the amount of the carbon element, more preferably 0.150 times or more the amount of the carbon element, and further preferably 0.170 times or more the amount of the carbon element, and preferably 0.250 times or less the amount of the carbon element. The amount of the nitrogen element is preferably 0.010 times or more the amount of the carbon element, and preferably 0.150 times or less the amount of the carbon element. By limiting the amount of the nitrogen element and/or the oxygen element at the surfaces of the surface-treated fibrous carbon nanostructures to the above-mentioned range, the electromagnetic wave absorption capacity of the electromagnetic wave absorption material in a high frequency domain of more than 20 GHz can be improved sufficiently.

The amount of the oxygen element and/or the nitrogen element at the surfaces of the surface-treated fibrous carbon nanostructures can be controlled to a desired range by adjusting, in the below-mentioned surface treatment step, various conditions such as surface treatment time and pressure and voltage applied in the treatment. An attempt to obtain, through surface treatment, such fibrous carbon nanostructures that have an amount of the nitrogen element and/or the oxygen element at the surfaces exceeding the above-mentioned upper limit could take long treatment time, and make production complex.

As used herein, “fibrous carbon nanostructures” typically denote a fibrous carbon material of less than 1 μm in outer diameter (fiber diameter). As used herein, “fiber” or “fibrous” typically denotes a structure with an aspect ratio of 5 or more.

A method of measuring the amount of each of the carbon element, the oxygen element, and the nitrogen element at the surfaces of the surface-treated fibrous carbon nanostructures will be described later in the examples section. Simply put, the amount of each of these elements can be obtained based on an X-ray diffraction pattern acquired by carrying out X-ray diffraction using 150 W (acceleration voltage 15 kV, current value 10 mA) AlKα monochromator X rays as an X-ray source in standard condition in accordance with JIS Z 8073, by an X-ray photoelectron spectrometer. The examples section describes the case where the amount of each of these elements is measured for surface-treated fibrous carbon nanostructures as a material used in the production of an electromagnetic wave absorption material or an electromagnetic wave absorber. However, the same results can achieved even when isolating a fibrous carbon nanomaterial contained in an electromagnetic wave absorption material or an electromagnetic wave absorber by a known appropriate method and performing measurement for the obtained fibrous carbon nanomaterial according to the method described in the examples section.

The surface-treated fibrous carbon nanostructures having the above-mentioned surface characteristics can be produced by performing the below-mentioned surface treatment step on commercially available fibrous carbon nanostructures or fibrous carbon nanostructures obtained as described later.

—Properties of Fibrous Carbon Nanostructures Before Surface Treatment—

The fibrous carbon nanostructures used in the production of the surface-treated fibrous carbon nanostructures are not limited. Examples include carbon nanotubes and vapor-grown carbon fibers. Any one of such fibrous carbon nanostructures may be used individually, or any two or more of such fibrous carbon nanostructures may be used in combination. Of these, fibrous carbon nanostructures including carbon nanotubes are preferably used as the fibrous carbon nanostructures. The use of the fibrous carbon nanostructures including carbon nanotubes limits aggregation of the resultant surface-treated fibrous carbon nanostructures. Hence, it is possible to obtain an electromagnetic wave absorption material capable of forming an electromagnetic wave absorption layer that has excellent absorption characteristics for an electromagnetic wave of a high frequency domain and, even in the case of being formed in thin film, has excellent durability. It is also possible to obtain an electromagnetic wave absorption material having surface-treated fibrous carbon nanostructures with excellent dispersibility and capable of forming an electromagnetic wave absorption layer with excellent conductivity and strength.

The fibrous carbon nanostructures including carbon nanotubes are not limited, and may be composed solely of carbon nanotubes (hereinafter also referred to as “CNTs”) or may be a mixture of CNTs and fibrous carbon nanostructures other than CNTs.

More preferably, the fibrous carbon nanostructures including carbon nanotubes have not undergone CNT opening formation treatment, and have a convex upward shape in a t-plot.

Typically, adsorption is a phenomenon in which gas molecules are taken onto a solid surface from the gas phase and is categorized as physical adsorption or chemical adsorption depending on the main cause of adsorption. The nitrogen gas adsorption method employed in the acquisition of t-plot utilizes physical adsorption. Usually, when the adsorption temperature is constant, the number of nitrogen gas molecules that are adsorbed by fibrous carbon nanostructures increases with increasing pressure. A plot of the relative pressure (ratio of pressure at adsorption equilibrium P and saturated vapor pressure P0) on a horizontal axis and the amount of adsorbed nitrogen gas on a vertical axis is referred to as an “isotherm.” The isotherm is referred to as an “adsorption isotherm” in a situation in which the amount of adsorbed nitrogen gas is measured while increasing the pressure and is referred to as a “desorption isotherm” in a situation in which the amount of adsorbed nitrogen gas is measured while decreasing the pressure.

The t-plot is obtained from the adsorption isotherm measured by the nitrogen gas adsorption method by converting the relative pressure to an average thickness t (nm) of an adsorbed layer of nitrogen gas. Specifically, an average adsorbed nitrogen gas layer thickness t corresponding to a given relative pressure is calculated from a known standard isotherm of average adsorbed nitrogen gas layer thickness t plotted against relative pressure P/P0 and the relative pressure is converted to the corresponding average adsorbed nitrogen gas layer thickness t to obtain a t-plot for the fibrous carbon nanostructures (t-plot method of de Boer et al.).

In a sample having pores at its surface, the growth of the adsorbed layer of nitrogen gas is categorized into the following processes (1) to (3). The gradient of the t-plot changes in accordance with these processes (1) to (3):

(1) a process in which a single molecular adsorption layer is formed over the entire surface by nitrogen molecules;

(2) a process in which a multi-molecular adsorption layer is formed in accompaniment to capillary condensation filling of pores; and

(3) a process in which a multi-molecular adsorption layer is formed on a surface that appears to be non-porous due to the pores being filled by nitrogen.

The t-plot of the fibrous carbon nanostructures used in the production of the surface-treated fibrous carbon nanostructures is on a straight line passing through the origin in a region in which the average adsorbed nitrogen gas layer thickness t is small, but, as t increases, the plot deviates downward from the straight line to form a convex upward shape. This shape of the t-plot indicates that the fibrous carbon nanostructures have a large internal specific surface area as a proportion of total specific surface area and that there are a large number of openings in the carbon nanostructures constituting the fibrous carbon nanostructures. This suppresses aggregation of the fibrous carbon nanostructures.

The bending point of the t-plot of the fibrous carbon nanostructures is preferably in a range satisfying 0.2≤t (nm)≤1.5, more preferably in a range satisfying 0.45≤t (nm)≤1.5, and further preferably in a range satisfying 0.55≤t (nm)≤1.0. If the position of the bending point of the t-plot is in the above-mentioned range, aggregation of the fibrous carbon nanostructures is further suppressed. With the use of the surface-treated fibrous carbon nanostructures obtained using such fibrous carbon nanostructures, an electromagnetic wave absorption material capable of forming an electromagnetic wave absorption layer having better absorption characteristics for an electromagnetic wave in a high frequency domain can be yielded.

Herein, the “position of the bending point” is an intersection point of an approximated straight line A for the above-mentioned process (1) and an approximated straight line B for the above-mentioned process (3).

The fibrous carbon nanostructures preferably have a ratio of an internal specific surface area S2 to a total specific surface area S1 (S2/S1) of 0.05 or more and 0.30 or less, obtained from the t-plot. If S2/S1 is 0.05 or more and 0.30 or less, aggregation of the fibrous carbon nanostructures is further suppressed. With the use of the surface-treated fibrous carbon nanostructures obtained using such fibrous carbon nanostructures, an electromagnetic wave absorption material capable of forming an electromagnetic wave absorption layer having better absorption characteristics for an electromagnetic wave in a high frequency domain can be yielded.

Each of the total specific surface area S1 and the internal specific surface area S2 of the fibrous carbon nanostructures is not limited, but S1 is preferably 400 m²/g or more and 2500 m²/g or less and further preferably 800 m²/g or more and 1200 m²/g or less, and S2 is preferably 30 m²/g or more and 540 m²/g or less.

The total specific surface area S1 and the internal specific surface area S2 of the fibrous carbon nanostructures can be found from the t-plot. Specifically, first, the total specific surface area S1 can be found from the gradient of the approximated straight line corresponding to the process (1) and an external specific surface area S3 can be found from the gradient of the approximated straight line corresponding to the process (3). The internal specific surface area S2 can then be calculated by subtracting the external specific surface area S3 from the total specific surface area S1.

The measurement of the adsorption isotherm, the preparation of the t-plot, and the calculation of the total specific surface area S1 and the internal specific surface area S2 based on t-plot analysis for the fibrous carbon nanostructures can be performed using, for example, BELSORP®-mini (BELSORP is a registered trademark in Japan, other countries, or both), a commercially available measurement instrument available from Bel Japan Inc.

In the case of using the fibrous carbon nanostructures including CNTs, the CNTs in the fibrous carbon nanostructures are not limited, and may be single-walled carbon nanotubes and/or multi-walled carbon nanotubes. The CNTs are preferably single- to up to 5-walled carbon nanotubes, and more preferably single-walled carbon nanotubes. The use of single-walled carbon nanotubes in the production of the surface-treated fibrous carbon nanostructures allows for further improvement in the balance between thin-film formability and electromagnetic wave absorption capacity in a high frequency domain, as compared with the case where multi-walled carbon nanotubes are used. Moreover, an electromagnetic wave absorption material having surface-treated fibrous carbon nanostructures with excellent dispersibility and capable of forming an electromagnetic wave absorption layer having better absorption characteristics for an electromagnetic wave in a high frequency domain can be yielded.

The fibrous carbon nanostructures may be a mixture of single-walled CNTs and multi-walled CNTs. In such a case, the content proportion of the single-walled CNTs is preferably 50 mass % or more. The content proportion of the single-walled CNTs and the multi-walled CNTs in the electromagnetic wave absorption material can be calculated, for example, from a number ratio obtained through observation under a transmission electron microscope.

The fibrous carbon nanostructures are preferably fibrous carbon nanostructures for which a ratio (3σ/Av) of the diameter standard deviation (σ) multiplied by 3 (3σ) relative to the average diameter (Av) is more than 0.20 and less than 0.60, more preferably fibrous carbon nanostructures for which 3σ/Av is more than 0.25, and further preferably fibrous carbon nanostructures for which 3σ/Av is more than 0.40. The use of fibrous carbon nanostructures for which 3σ/Av is more than 0.20 and less than 0.60 enables the obtainment of an electromagnetic wave absorption material capable of forming an electromagnetic wave absorption layer having better electromagnetic wave absorption capacity in a high frequency domain, using surface-treated fibrous carbon nanostructures yielded using the fibrous carbon nanostructures.

Herein, the “average diameter (Av) of the fibrous carbon nanostructures” and the “diameter standard deviation (σ: sample standard deviation) of the fibrous carbon nanostructures” can each be obtained by measuring the diameters (external diameters) of 100 randomly selected fibrous carbon nanostructures using a transmission electron microscope. The average diameter (Av) and the standard deviation (σ) of the fibrous carbon nanostructures may be adjusted by changing the production method and the production conditions of the fibrous carbon nanostructures, or adjusted by combining a plurality of types of fibrous carbon nanostructures obtained by different production methods.

The fibrous carbon nanostructures that are typically used take a normal distribution when a plot is made of diameter measured as described above on a horizontal axis and probability density on a vertical axis, and a Gaussian approximation is made.

Furthermore, the fibrous carbon nanostructures preferably exhibit a radial breathing mode (RBM) peak when evaluated by Raman spectroscopy. Note that an RBM is not present in the Raman spectrum of fibrous carbon nanostructures composed only of multi-walled carbon nanotubes having three or more walls.

Moreover, in a Raman spectrum of the fibrous carbon nanostructures, a ratio (G/D ratio) of G band peak intensity relative to D band peak intensity is preferably 1 or more and 20 or less. If the G/D ratio is 1 or more and 20 or less, dispersibility in an electromagnetic wave absorption material of surface-treated fibrous carbon nanostructures obtained using such fibrous carbon nanostructures is improved, and an electromagnetic wave absorption material capable of forming an electromagnetic wave absorption layer having better absorption characteristics for an electromagnetic wave in a high frequency domain is obtained.

The number average diameter (Av) of the fibrous carbon nanostructures is preferably 0.5 nm or more and more preferably 1 nm or more, and preferably 15 nm or less and more preferably 10 nm or less. If the number average diameter (Av) of the fibrous carbon nanostructures is 0.5 nm or more, the electromagnetic wave absorption capacity in a high frequency domain of an electromagnetic wave absorption material formed using surface-treated fibrous carbon nanostructures obtained using such fibrous carbon nanostructures can be further enhanced. In addition, the surface-treated fibrous carbon nanostructures in the electromagnetic wave absorption material have excellent dispersibility. If the number average diameter (Av) of the fibrous carbon nanostructures is 15 nm or less, the fibrous carbon nanostructures are flexible. Accordingly, even in the case where an electromagnetic wave absorption material formed using surface-treated fibrous carbon nanostructures obtained using such fibrous carbon nanostructures is warped, the surface-treated fibrous carbon nanostructures are unlikely to break, and the electromagnetic wave absorption capacity can be maintained.

The fibrous carbon nanostructures preferably include 90% or more fibrous carbon nanostructures with a diameter of 15 nm or less. Hence, the flexibility of an electromagnetic wave absorption material formed using surface-treated fibrous carbon nanostructures obtained using such fibrous carbon nanostructures can be further improved, and the electromagnetic wave absorption capacity in use state can be improved efficiently. Herein, “efficiently improving the electromagnetic wave absorption capacity” means that, even in the case where the amount of surface-treated fibrous carbon nanostructures contained in the electromagnetic wave absorption material is small, electromagnetic wave absorption capacity equivalent to that of a conventional electromagnetic wave absorption material containing fibrous carbon nanostructures can be achieved.

The average length of a structure of the fibrous carbon nanostructures at the time of synthesis is preferably 100 μm or more. Fibrous carbon nanostructures that have a longer structure length at the time of synthesis tend to be more easily damaged by breaking, severing, or the like during dispersion. Therefore, it is preferable that the average length of the structure at the time of synthesis is 5000 μm or less.

The aspect ratio (length/diameter) of the fibrous carbon nanostructures is preferably more than 10. The aspect ratio of the fibrous carbon nanostructures can be found by measuring the diameters and lengths of 100 fibrous carbon nanostructures randomly selected by a transmission electron microscope and calculating the average of ratios of length to diameter (length/diameter).

The BET specific surface area of the fibrous carbon nanostructures is preferably 200 m²/g or more, more preferably 400 m²/g or more, more preferably 600 m²/g or more, and further preferably 800 m²/g or more, and preferably 2500 m²/g or less and more preferably 1200 m²/g or less. If the BET specific surface area of the fibrous carbon nanostructures is 200 m²/g or more, the electromagnetic wave absorption capacity in a high frequency domain of an electromagnetic wave absorption material formed using surface-treated fibrous carbon nanostructures obtained using such fibrous carbon nanostructures can be sufficiently ensured. If the BET specific surface area of the fibrous carbon nanostructures is 2500 m²/g or less, the film formability of an electromagnetic wave absorption material formed using surface-treated fibrous carbon nanostructures obtained using such fibrous carbon nanostructures can be improved.

As used herein, “BET specific surface area” refers to a nitrogen adsorption specific surface area measured by the BET method.

In accordance with the super growth method described later, the fibrous carbon nanostructures are obtained, on a substrate having thereon a catalyst layer for carbon nanotube growth, in the form of an aggregate wherein fibrous carbon nanostructures are aligned substantially perpendicularly to the substrate (aligned aggregate). The mass density of the fibrous carbon nanostructures in the form of such an aggregate is preferably 0.002 g/cm³ or more and 0.2 g/cm³ or less. A mass density of 0.2 g/cm³ or less allows the fibrous carbon nanostructures to be homogeneously dispersed because binding among the fibrous carbon nanostructures is weakened. Consequently, the electromagnetic wave absorption capacity in a high frequency domain of an electromagnetic wave absorption material formed using surface-treated fibrous carbon nanostructures obtained using such fibrous carbon nanostructures can be further enhanced. A mass density of 0.002 g/cm³ or more improves the unity of the fibrous carbon nanostructures, thus preventing the fibrous carbon nanostructures from becoming unbound and making the fibrous carbon nanostructures easier to handle.

The fibrous carbon nanostructures preferably include a plurality of micropores. In particular, the fibrous carbon nanostructures preferably include micropores that have a pore diameter of less than 2 nm. The amount of these micropores as measured in terms of micropore volume determined by the method described below is preferably 0.40 mL/g or more, more preferably 0.43 mL/g or more, and further preferably 0.45 mL/g or more, with the upper limit being generally on the order of 0.65 mL/g. The presence of such micropores in the fibrous carbon nanostructures further limits aggregation of the fibrous carbon nanostructures. Micropore volume can be adjusted, for example, by appropriate alteration of the production method and the production conditions of the fibrous carbon nanostructures.

Herein, “micropore volume (Vp)” can be calculated using Equation (I): Vp=(V/22414)×(M/ρ) by measuring a nitrogen adsorption isotherm of the fibrous carbon nanostructures at liquid nitrogen temperature (77 K) with the amount of adsorbed nitrogen at a relative pressure P/P0=0.19 defined as V, where P is a measured pressure at adsorption equilibrium, and P0 is a saturated vapor pressure of liquid nitrogen at time of measurement. In Equation (I), M is a molecular weight of 28.010 of the adsorbate (nitrogen), and p is a density of 0.808 g/cm³ of the adsorbate (nitrogen) at 77 K. Micropore volume can be measured, for example, using BELSORP®-mini produced by Bel Japan Inc.

The fibrous carbon nanostructures can be efficiently produced, for example, by forming a catalyst layer on a substrate surface by wet process in the method (super growth method, see WO2006/011655) wherein during synthesis of CNTs through chemical vapor deposition (CVD) by supplying a feedstock compound and a carrier gas onto a substrate having thereon a catalyst layer for carbon nanotube production, the catalytic activity of the catalyst layer is dramatically improved by providing a trace amount of an oxidizing agent (catalyst activating material) in the system. Hereinafter, carbon nanotubes obtained by the super growth method are also referred to as “SGCNTs.”

The fibrous carbon nanostructures produced by the super growth method may be composed solely of SGCNTs, or may be composed of SGCNTs and electrically conductive non-cylindrical carbon nanostructures. Specifically, the fibrous carbon nanostructures may include single- or multi-walled flattened cylindrical carbon nanostructures having over the entire length a tape portion where inner walls are in close proximity to each other or bonded together (hereinafter such carbon nanostructures are also referred to as “graphene nanotapes (GNTs)”).

The phrase “having over the entire length a tape portion” as used herein refers to “having a tape portion over 60% or more, preferably 80% or more, more preferably 100% of the length of the longitudinal direction (entire length), either continuously or intermittently.”

GNT is presumed to be a substance having over the entire length a tape portion where inner walls are in close proximity to each other or bonded together since it has been synthesized, and having a network of 6-membered carbon rings in the form of flattened cylindrical shape. GNT's flattened cylindrical structure and the presence of a tape portion where inner walls are in close proximity to each other or bonded together in the GNT can be confirmed, for example, as follows: GNT and fullerene (C60) are sealed into a quartz tube and subjected to heat treatment under reduced pressure (fullerene insertion treatment) to form a fullerene-inserted GNT, followed by observation under a transmission electron microscope (TEM) of the fullerene-inserted GNT to confirm the presence of part in the GNT where no fullerene is inserted (tape portion).

The shape of the GNT is preferably such that it has a tape portion at the central part in the width direction. More preferably, the shape of a cross-section of the GNT, perpendicular to the extending direction (axial direction), is such that the maximum dimension in a direction perpendicular to the longitudinal direction of the cross section is larger in the vicinity of opposite ends in the longitudinal direction of the cross section than in the vicinity of the central part in the longitudinal direction of the cross section. Most preferably, a cross-section of the GNT perpendicular to the extending direction (axial direction) has a dumbbell shape.

The term “vicinity of the central part in the longitudinal direction of a cross section” used for the shape of a cross section of GNT refers to a region within 30% of longitudinal dimension of the cross section from the line at the longitudinal center of the cross section (i.e., a line that passes through the longitudinal center of the cross section and is perpendicular to the longitudinal line in the cross section). The term “vicinity of opposite ends in the longitudinal direction of a cross section” refers to regions outside the “vicinity of the central part in the longitudinal direction of a cross section” in the longitudinal direction.

Fibrous carbon nanostructures including GNTs as non-cylindrical carbon nanostructures can be obtained by, when synthesizing CNTs by the super growth method using a substrate having thereon a catalyst layer (hereinafter also referred to as a “catalyst substrate”), forming the catalyst substrate using a specific method. Specifically, fibrous carbon nanostructures including GNTs can be obtained through synthesis of CNTs by the super growth method using a catalyst substrate prepared as follows: Coating liquid A containing an aluminum compound is applied on a substrate and dried to form an aluminum thin film (catalyst support layer) on the substrate, followed by application of coating liquid B containing an iron compound on the aluminum thin film and drying of the coating liquid B at a temperature of 50° C. or less to form an iron thin film (catalyst layer) on the aluminum thin film.

The concentration of metal impurities contained in the fibrous carbon nanostructures is preferably less than 5000 ppm, and more preferably less than 1000 ppm, in terms of reducing impurities in an electromagnetic wave absorption material formed using surface-treated fibrous carbon nanostructures obtained using such fibrous carbon nanostructures and enabling the production of a long-life product.

As used herein, the concentration of metal impurities can be measured, for example, by a transmission electron microscope (TEM), a scanning electron microscope (SEM), energy dispersive X-ray analysis (EDAX), a vapor-phase decomposition device and ICP mass spectrometry (VPD, ICP/MS), etc.

Herein, metal impurities include, for example, a metal catalyst used in the production of the fibrous carbon nanostructures. Examples include metal elements to which alkali metal, alkaline-earth metal, groups 3 to 13, and lanthanoid group belong, metal elements such as Si, Sb, As, Pb, Sn, and Bi, and metal compounds containing these elements. More specific examples include metal elements such as Al, Sb, As, Ba, Be, Bi, B, Cd, Ca, Cr, Co, Cu, Ga, Ge, Fe, Pb, Li, Mg, Mn, Mo, Ni, K, Na, Sr, Sn, Ti, W, V, Zn, and Zr, and metal compounds containing these elements.

In terms of further improving the dispersibility of the fibrous carbon nanostructures in the electromagnetic wave absorption material and enabling the formation of a uniform electromagnetic wave absorption layer, the fibrous carbon nanostructures preferably do not substantially contain particulate impurities with a particle diameter of more than 500 nm, more preferably do not substantially contain particulate impurities with a particle diameter of more than 300 nm, further preferably do not substantially contain particulate impurities with a particle diameter of more than 100 nm, and particularly preferably do not substantially contain particulate impurities with a particle diameter of more than 45 nm.

As used herein, the concentration of particulate impurities can be measured by applying a fibrous carbon nanostructure dispersion liquid onto a substrate and measuring the surface using, for example, “surfscan” produced by KLA Tencor Corporation.

<Insulating Material>

The insulating material is not limited, and known resins and fillers may be used depending on the use of the electromagnetic wave absorption material. As used herein, a substance having “insulation property” such as an insulating material preferably has a volume resistivity measured in accordance with JIS K 6911 of 10¹¹ Ω·cm or more.

As the insulating material, an insulating material obtained by optionally mixing an insulating filler with resin may be used. As used herein, rubbers and elastomers are included in “resin”. In particular, resin satisfying the above-mentioned volume resistivity condition is also referred to as “insulating resin”. As used herein, the insulating material is preferably insulating resin, because the balance between flexibility and durability of the electromagnetic wave absorption material can be improved.

[Resin]

Examples of the resin include: natural rubber including epoxidized natural rubber, diene-based synthetic rubber (butadiene rubber, epoxidized butadiene rubber, styrene-butadiene rubber, (hydrogenated) acrylonitrile-butadiene rubber, ethylene vinyl acetate rubber, chloroprene rubber, vinylpyridine rubber, butyl rubber, chlorobutyl rubber, polyisoprene rubber), ethylene-propylene rubber (EPR, EPDM), acrylic rubber, silicone rubber, epichlorohydrin rubber (CO, ECO), urethane rubber, polysulfide rubber, fluororubber, fluororesin, urea resin, melamine resin, phenol resin, cellulosic resin such as cellulose acetate, cellulose nitrate, and cellulose acetate butyrate; casein plastic; soybean protein plastic; benzoguanamine resin; epoxy-based resin such as bisphenol A-type epoxy resin, novolak-type epoxy resin, polyfunctionalized epoxy resin, and alicyclic epoxy resin; diallyl phthalate resin; alkyd resin; polyvinyl chloride resin, polyethylene resin; polypropylene resin; styrene-based resin such as ABS (acrylonitrile-butadiene-styrene) resin, AS (acrylonitrile-styrene) resin, and polystyrene; acrylic resin; methacrylic resin; organic acid vinyl ester-based resin such as polyvinyl acetate; vinyl ether resin; halogen-containing resin; polycycloolefin resin; olefin resin; alicyclic olefin resin; polycarbonate resin; polyester resin including unsaturated polyester resin; polyamide resin; thermoplastic and thermosetting polyurethane resin; polysulfone resin; polyphenylene ether resin including modified polyphenylene ether resin; silicone resin; polyacetal resin; polyimide resin; polyethylene terephthalate resin; polybutylene terephthalate resin; polyarylate resin; polyphenylene sulfide resin; and polyether ether ketone resin. One of these resins may be used individually, or two or more of these resins may be used as a mixture.

[Insulating Filler]

The insulating filler is not limited, and an insulating filler such as a known inorganic filler or organic filler may be used. Examples of the insulating filler include silica, talc, clay, titanium oxide, nylon fiber, vinylon fiber, acrylic fiber, and rayon fiber. One of these fillers may be used individually, or two or more of these fillers may be used as a mixture

[Other Components]

The presently disclosed electromagnetic wave absorption material may contain known additives depending on the intended use. Examples of the known additives include an antioxidant, a thermal stabilizer, a light stabilizer, an ultraviolet absorber, a cross-linking agent, a pigment, a coloring agent, a foaming agent, an antistatic agent, a flame retardant, a lubricant, a softener, a tackifier, a plasticizer, a mold release agent, a deodorizer, and perfume.

<Content of Fibrous Carbon Nanostructures>

The electromagnetic wave absorption material preferably has a content A of the surface-treated fibrous carbon nanostructures of 0.5 parts by mass or more and 15 parts by mass or less, in the case where the content of the insulating material is 100 parts by mass. The content A is more preferably 0.8 parts by mass or more, further preferably 1.0 parts by mass or more, and still further preferably 1.5 parts by mass or more, and more preferably 10 parts by mass or less, and further preferably 7 parts by mass or less. By limiting the content A to this range, the electromagnetic wave absorption capacity of the electromagnetic wave absorption material in a high frequency domain can be further improved. As used herein, the content of each material in the production of the electromagnetic wave absorption material is equal to the content of the corresponding material in the produced electromagnetic wave absorption material.

<Properties of Electromagnetic Wave Absorption Material>

### —Reflection Attenuation Amount in High Frequency Domain—

The electromagnetic wave absorption material absorbs an electromagnetic wave of a frequency domain of more than 20 GHz. In particular, the reflection attenuation amount of the electromagnetic wave absorption material for an electromagnetic wave of a frequency of 60 GHz is preferably 9 dB or more, and more preferably 10 dB or more. The reflection attenuation amount of the electromagnetic wave absorption material for an electromagnetic wave of a frequency of 76 GHz is preferably 9 dB or more, and more preferably 10 dB or more. Furthermore, it is preferable that the reflection attenuation amount of the electromagnetic wave absorption material in a frequency range of more than 60 GHz and less than 76 GHz is always higher than a smaller value of respective reflection attenuation amounts at frequencies of 60 GHz and 76 GHz. If the reflection attenuation amount in a high frequency domain such as frequencies of 60 GHz and 76 GHz is in the above-mentioned range, excellent electromagnetic wave cutoff performance in a high frequency domain can be achieved.

As used herein, “reflection attenuation amount” can be measured by the method described in the examples section.

(Electromagnetic Wave Absorber)

The presently disclosed electromagnetic wave absorber includes at least one electromagnetic wave absorption layer containing fibrous carbon nanostructures and insulating resin. The electromagnetic wave absorption layer included in the presently disclosed electromagnetic wave absorber is preferably an electromagnetic wave absorption layer formed in layer (film) form using the presently disclosed electromagnetic wave absorption material, i.e. an electromagnetic wave absorption layer including the presently disclosed electromagnetic wave absorption material. The presently disclosed electromagnetic wave absorber more preferably includes an electromagnetic wave absorption layer made of the presently disclosed electromagnetic wave absorption material. The electromagnetic wave absorber including the electromagnetic wave absorption layer formed using the presently disclosed electromagnetic wave absorption material has excellent electromagnetic wave absorption capacity in a high frequency domain.

As used herein, the term “electromagnetic wave absorber” denotes a structure including an electromagnetic wave absorption layer obtained by shaping, in layer (film) form, a material containing insulating resin and fibrous carbon nanostructures. On the other hand, the term “electromagnetic wave absorption material” denotes, for example, an electromagnetic wave absorption material in a state of being present as a material before being shaped as an electromagnetic wave absorption layer, and, in a broader sense, includes a shaped product that is shaped in a shape/structure not including an electromagnetic wave absorption layer.

[Structure of Electromagnetic Wave Absorber]

The presently disclosed electromagnetic wave absorber may be a single-layer electromagnetic wave absorber including a single electromagnetic wave absorption layer, or a multi-layer electromagnetic wave absorber including a plurality of electromagnetic wave absorption layers.

In particular, in the case where the presently disclosed electromagnetic wave absorber is a multi-layer electromagnetic wave absorber, the presently disclosed electromagnetic wave absorber includes a plurality of electromagnetic wave absorption layers each including surface-treated fibrous carbon nanostructures and an insulating material. The surface-treated fibrous carbon nanostructures and/or the insulating materials included in the respective layers may be of the same type or different types. In the case where the plurality of electromagnetic wave absorption layers are denoted as a first electromagnetic wave absorption layer, a second electromagnetic wave absorption layer, . . . , and an nth electromagnetic wave absorption layer from the side farther from the electromagnetic wave incidence side and the contents of the surface-treated fibrous carbon nanostructures in the respective electromagnetic wave absorption layers are denoted as A1 parts by mass, A2 parts by mass, . . . , and An parts by mass where the content of the insulating material is 100 parts by mass, the following formulas (1) and any of (2) and (3) hold true. In terms of the productivity of the electromagnetic wave absorber, it is preferable that n=2 to 5.

0.5≤A1≤15 (1)

A1>A2, when n is 2 (2)

A1>A2≥ . . . An, when n is a natural number of 3 or more (3).

Moreover, it is preferable that the first electromagnetic wave absorption layer from among all layers constituting the electromagnetic wave absorber has a highest content of surface-treated fibrous carbon nanostructures, and that, at the surfaces of the surface-treated fibrous carbon nanostructures, the amount of the oxygen element is 0.030 times or more and 0.300 times or less the amount of the carbon element and/or the amount of the nitrogen element is 0.005 times or more and 0.200 times or less the amount of the carbon element.

Thus, by forming, in the electromagnetic wave absorber including the plurality of electromagnetic wave absorption layers, such a concentration gradient of surface-treated fibrous carbon nanostructures that increases from the side nearer the electromagnetic wave incidence side toward the side farther from the electromagnetic wave incidence side, it is possible to allow an electromagnetic wave to enter deeply into the electromagnetic wave absorber. This can suppress an excessive temperature increase only in the vicinity of the surface of the electromagnetic wave absorber facing the electromagnetic wave incidence side. Furthermore, with such a structure, an electromagnetic wave incident from a direction inclined with respect to a normal line of the electromagnetic wave absorber (direction diagonal to the surface) can be absorbed, too. Hence, the electromagnetic wave absorption performance of the electromagnetic wave absorber can be enhanced. Herein, “normal line of the electromagnetic wave absorber” is a normal line of the electromagnetic wave absorber with respect to the outermost surface on the electromagnetic wave incidence side.

The content A1 in the first layer is preferably 1 or more, and preferably 10 or less and more preferably 8 or less.

The contents A2 to An in the second layer to the nth layer need not necessarily be 0.5 or more as with the first electromagnetic wave absorption layer, and may be less than 0.5. Specifically, the contents A2 to An are preferably 0.1 or more, more preferably 0.5 or more, and further preferably 1.0 or more, and preferably 3.0 or less. In particular, regarding the contents A1 to An in the adjacent electromagnetic wave absorption layers, a ratio (Aᵢ₊₁/Aᵢ) is preferably 1/5 or more and 1/2 or less, where Aᵢ and Aᵢ₊₁ are the respective surface-treated fibrous carbon nanostructure contents of any two adjacent layers.

Although another layer may be provided between the plurality of electromagnetic wave absorption layers, the electromagnetic wave absorption layers are preferably adjacent to each other. Thus, the electromagnetic wave absorption capacity in a high frequency domain can be further improved.

The surface-treated fibrous carbon nanostructures contained in the plurality of electromagnetic wave absorption layers are preferably the same. With such a structure, the electromagnetic wave absorption layer production efficiency can be enhanced.

The insulating materials contained in the plurality of electromagnetic wave absorption layers may be the same or different, but are preferably the same. With such a structure, the electromagnetic wave absorption layer production efficiency can be enhanced.

[Insulating Layer]

The presently disclosed electromagnetic wave absorber preferably includes an insulating layer at the outermost surface on the electromagnetic wave incidence side. The insulating layer may be any insulating layer having a volume resistivity measured in accordance with HS K 6911 of 10¹¹ Ω·cm or more. The insulating layer contains an insulating material. The insulating material is not limited, and may be an insulating material that can be blended in the electromagnetic wave absorption material. The insulating material contained in the electromagnetic wave absorption layer and the insulating material contained in the insulating layer may be the same or different. The insulating layer may optionally contain known additives such as those described above with regard to the electromagnetic wave absorption material.

Such an electromagnetic wave absorber has better electromagnetic wave absorption capacity in a high frequency domain of more than 20 GHz, and has excellent durability in the case where the electromagnetic wave absorber is thin. The versatility of the electromagnetic wave absorber can be enhanced by providing the insulating layer at the outermost surface of the electromagnetic wave absorber.

[Thickness of Electromagnetic Wave Absorber]

### —Thickness of Single-Layer Electromagnetic Wave Absorber—

In the case where the presently disclosed electromagnetic wave absorber is single-layer type, the thickness of the electromagnetic wave absorption layer in the single-layer electromagnetic wave absorber is preferably 500 μm or less, more preferably 100 μm or less, further preferably 80 μm or less, and particularly preferably 60 μm or less, and preferably 1 μm or more, more preferably 10 μm or more, and further preferably 25 μm or more. If the thickness of the electromagnetic wave absorber in film form is 500 μm or less, the electromagnetic wave absorption capacity in a high frequency domain can be further enhanced sufficiently. Moreover, the electromagnetic wave absorber in film form with a thickness in the above-mentioned range is usable in various applications, and so has high versatility.

The thickness of the electromagnetic wave absorption material in film form can be freely controlled in a shaping step in the below-mentioned production method.

In the case where the presently disclosed electromagnetic wave absorber includes an insulating layer, the total thickness of the presently disclosed electromagnetic wave absorber is preferably 500 μm or less, more preferably 200 μm or less, further preferably 120 μm or less, and particularly preferably 100 μm or less, and preferably 1 μm or more, and more preferably 10 μm or more. If the total thickness of the electromagnetic wave absorber is in the above-mentioned range, the electromagnetic wave absorption capacity in a high frequency domain can be sufficiently ensured, and also the free-standing ability as a film can be sufficiently ensured.

—Thickness of Multi-Layer Electromagnetic Wave Absorber—

In the case where the presently disclosed electromagnetic wave absorber is a multi-layer electromagnetic wave absorber, the total thickness of the plurality of electromagnetic wave absorption layers is preferably in the same numeric value range as the single-layer type.

(Production Method for Electromagnetic Wave Absorption Material and Electromagnetic Wave Absorber)

The presently disclosed electromagnetic wave absorption material and electromagnetic wave absorber can be produced through: a step of surface-treating fibrous carbon nanostructures (fibrous carbon nanostructure surface treatment step); a step of dispersing the fibrous carbon nanostructures and an insulating material in a solvent to obtain an electromagnetic wave absorption material slurry composition (electromagnetic wave absorption material slurry composition production step); and a step of yielding an electromagnetic wave absorption material or an electromagnetic wave absorber from the obtained electromagnetic wave absorption material slurry composition (shaping step).

<Fibrous Carbon Nanostructure Surface Treatment Step>

In the fibrous carbon nanostructure surface treatment step (hereafter also simply referred to as “surface treatment step”), the fibrous carbon nanostructures described above are subjected to plasma treatment and/or ozone treatment. By the plasma treatment and/or ozone treatment, the amount of the oxygen element and/or the amount of the nitrogen element at the surfaces of the surface-treated fibrous carbon nanostructures can be increased.

[Plasma Treatment]

For example, the plasma treatment of the fibrous carbon nanostructures may be carried out by placing the fibrous carbon nanostructures as a surface treatment target into a container containing argon, neon, helium, nitrogen, nitrogen dioxide, oxygen, air, or the like, and exposing the fibrous carbon nanostructures to plasma generated by glow discharge. Examples of discharge modes for plasma generation include (1) DC discharge and low-frequency discharge, (2) radio wave discharge, and (3) microwave discharge.

The plasma treatment conditions are not limited. As the treatment strength, the energy output per unit area of the plasma irradiation surface is preferably 0.05 W/cm² to 2.0 W/cm², and the gas pressure is preferably 5 Pa to 150 Pa. The treatment time may be selected as appropriate, but is typically 1 min to 300 min, preferably 10 min to 180 min, and more preferably 15 min to 120 min.

[Ozone Treatment]

The ozone treatment of the fibrous carbon nanostructures is carried out by exposing the fibrous carbon nanostructures to ozone. The exposure method may be any appropriate method, such as a method of retaining the fibrous carbon nanostructures in an atmosphere containing ozone for a predetermined time, or a method of bringing ozone gas flow into contact with the fibrous carbon nanostructures for a predetermined time.

Ozone that is brought into contact with the fibrous carbon nanostructures can be generated by supplying oxygen-containing gas, such as air, gaseous oxygen, or oxygen-enriched air, to an ozone generator. The resultant ozone-containing gas is introduced into a container, a treatment vessel, or the like containing the fibrous carbon nanostructures, to perform the ozone treatment. Various conditions such as the ozone concentration in the ozone-containing gas, the exposure time, and the exposure temperature may be set as appropriate based on the amount of dispersant remaining in the fibrous carbon nanostructures and the intended dispersant removal rate. For example, the ozone treatment may be performed by generating, in a treatment vessel containing a solution obtained by dispersing the fibrous carbon nanostructures as a surface treatment target in a suitable solvent, a reaction site through supply of ozone so that the ozone concentration in the treatment vessel is 0.3 mg/l to 20 mg/l, and performing reaction at a temperature of 0° C. to 80° C. typically for 1 min to 48 hr.

<Electromagnetic Wave Absorption Material Slurry Composition Production Step>

In the electromagnetic wave absorption material slurry composition production step (hereafter also simply referred to as “slurry composition production step”), the surface-treated fibrous carbon nanostructures obtained in the surface treatment step and the insulating material are dispersed in a solvent, to produce an electromagnetic wave absorption material slurry composition (hereafter also simply referred to as “slurry composition”).

[Solvent]

In the slurry composition production step, the solvent is not limited. Examples of solvents that can be used include: water; alcohols such as methanol, ethanol, n-propanol, isopropanol, n-butanol, isobutanol, t-butanol, pentanol, hexanol, heptanol, octanol, nonanol, and decanol; ketones such as acetone, methyl ethyl ketone, and cyclohexanone; esters such as ethyl acetate and butyl acetate; ethers such as diethyl ether, dioxane, and tetrahydrofuran; amide-based polar organic solvents such as N,N-dimethylformamide and

N-methylpyrrolidone; and aromatic hydrocarbons such as toluene, xylene, chlorobenzene, ortho-dichlorobenzene, and para-dichlorobenzene. One of these solvents may be used individually, or two or more of these solvents may be used as a mixture.

[Additives]

The additives optionally contained in the slurry composition are not limited, and may be additives typically used in the production of a dispersion liquid such as a dispersant. The dispersant used in the slurry composition production step is not limited as long as it is capable of dispersing the fibrous carbon nanostructures and can be dissolved in the above-mentioned solvent, and may be a surfactant.

Examples of the surfactant include sodium dodecylsulfonate, sodium deoxycholate, sodium cholate, and sodium dodecylbenzenesulfonate.

One of these dispersants may be used individually, or two or more of these dispersants may be used as a mixture.

[Dispersion Treatment in Slurry Composition Production Step]

As the dispersion method in the slurry composition production step, a typical dispersion method using a nanomizer, an ultimizer, an ultrasonic disperser, a ball mill, a sand grinder, a dyno-mill, a spike mill, a DCP mill, a basket mill, a paint conditioner, a high-speed stirring device, or the like may be employed without being limited thereto.

—Fibrous Carbon Nanostructure Dispersion Liquid Production Step—

In the slurry composition production step, a step of producing a fibrous carbon nanostructure dispersion liquid beforehand prior to mixing with the insulating material (fibrous carbon nanostructure dispersion liquid production step) is preferably performed. In the fibrous carbon nanostructure dispersion liquid production step, it is preferable to add the fibrous carbon nanostructures to a solvent, and subject a preliminary dispersion liquid obtained through dispersion by a typical dispersion method to dispersion treatment that brings about a cavitation effect or dispersion treatment that brings about a crushing effect described in detail below, to produce a fibrous carbon nanostructure dispersion liquid.

[[Dispersion Treatment that Brings about Cavitation Effect]]

The dispersion treatment that brings about a cavitation effect is a dispersion method that utilizes shock waves caused by the rupture of vacuum bubbles formed in water when high energy is applied to the liquid. This dispersion method can be used to favorably disperse the fibrous carbon nanostructures.

The dispersion treatment that brings about a cavitation effect is preferably performed at a temperature of 50° C. or less, in terms of suppressing a change in concentration due to solvent volatilization. Specific examples of the dispersion treatment that brings about a cavitation effect include dispersion treatment using ultrasound, dispersion treatment using a jet mill, and dispersion treatment using high-shear stirring. One of these dispersion treatments may be carried out or a plurality of these dispersion treatments may be carried out in combination. More specifically, an ultrasonic homogenizer, a jet mill, and a high-shear stirring device are preferably used. Commonly known conventional devices may be used as these devices.

In a situation in which the dispersion of the slurry composition is performed using an ultrasonic homogenizer, the coarse dispersion liquid is irradiated with ultrasound by the ultrasonic homogenizer. The irradiation time may be set as appropriate in consideration of the amount of fibrous carbon nanostructures and so forth.

In a situation in which a jet mill is used, the number of treatment repetitions carried out is set as appropriate in consideration of the amount of fibrous carbon nanostructures and so forth. For example, the number of treatment repetitions is preferably at least 2 repetitions, and more preferably at least 5 repetitions, and is preferably no greater than 100 repetitions, and more preferably no greater than 50 repetitions. Furthermore, the pressure is preferably 20 MPa to 250 MPa, and the temperature is preferably 15° C. to 50° C. In the case where a jet mill is used, a surfactant is preferably added as a dispersant to the solvent. This reduces the viscosity of the treatment liquid, and enables the jet mill to operate stably. An example of such a jet mill is a high-pressure wet jet mill. Specific examples encompass “Nanomaker®” (Nanomaker is a registered trademark in Japan, other countries, or both) (manufactured by Advanced Nano Technology Co., Ltd.), “Nanomizer” (manufactured by Nanomizer Inc.), “NanoVater” (manufactured by Yoshida Kikai Co. Ltd.), and “Nano Jet Pal®” (Nano Jet Pal is a registered trademark in Japan, other countries, or both) (manufactured by Jokoh Co., Ltd.).

In a situation in which high-shear stirring is used, the coarse dispersion liquid is subjected to stirring and shearing using a high-shear stirring device. The rotational speed is preferably as fast as possible. The operating time (i.e., the time during which the device is rotating) is preferably 3 min or more and 4 hr or less, the circumferential speed is preferably 20 m/s or more and 50 m/s or less, and the temperature is preferably 15° C. or more and 50° C. or less. In the case where a high-shear stirring device is used, polysaccharides are preferable as a dispersant. A polysaccharide aqueous solution is highly viscous and therefore high shearing stress can be easily applied. This further facilitates the dispersion. Examples of such a high-shear stirring device encompass: stirrers typified by “Ebara Milder” (manufactured by Ebara Corporation), “CAVITRON” (manufactured by Eurotec Co., Ltd.), and “DRS2000” (manufactured by Ika Works, Inc.); stirrers typified by “CLEARMIX® CLM-0.8S” (CLEARMIX is a registered trademark in Japan, other countries, or both) (manufactured by M Technique Co., Ltd.); turbine-type stirrers typified by “T.K. Homo Mixer” (manufactured by Tokushu Kika Kogyo Co., Ltd.); and stirrers typified by “TK Fillmix” (manufactured by Tokushu Kika Kogyo Co., Ltd.).

The dispersion treatment that brings about a cavitation effect is more preferably performed at a temperature of 50° C. or less. This suppresses a change in concentration due to solvent volatilization.

[[Dispersion Treatment that Brings about Crushing Effect]]

Dispersion treatment that brings about a crushing effect is even more advantageous because, in addition to enabling uniform dispersion of the fibrous carbon nanostructures, dispersion treatment that brings about a crushing effect reduces damage to the fibrous carbon nanostructures due to shock waves when air bubbles burst compared to the above-mentioned dispersion treatment that brings about a cavitation effect.

The dispersion treatment that brings about a crushing effect uniformly disperses the fibrous carbon nanostructures in the solvent by causing crushing and dispersion of the fibrous carbon nanostructures by imparting shear force to the coarse dispersion liquid and by further applying back pressure to the coarse dispersion liquid, while cooling the coarse dispersion liquid as necessary in order to reduce air bubble formation.

When applying back pressure to the coarse dispersion liquid, the back pressure may be applied to the coarse dispersion liquid by lowering pressure at once to atmospheric pressure, yet the pressure is preferably lowered over multiple steps.

In order to further disperse the fibrous carbon nanostructures in the coarse dispersion liquid by applying a shear force to the coarse dispersion liquid, a dispersion system including a disperser with the structure below, for example, may be used.

From the side where the coarse dispersion liquid flows in to the side where the coarse dispersion liquid flows out, the disperser is sequentially provided with a disperser orifice having an inner diameter d1, a dispersion space having an inner diameter d2, and a terminal section having an inner diameter d3 (where d2>d3>d1).

In this disperser, by passing through the disperser orifice, high-pressure (e.g. 10 MPa to 400 MPa, preferably 50 MPa to 250 MPa) coarse dispersion liquid that flows in is reduced in pressure while becoming a high flow rate fluid that then flows into the dispersion space. Subsequently, the high flow rate coarse dispersion liquid that has entered the dispersion space flows in the dispersion space at high speed, receiving a shear force at that time. As a result, the flow rate of the coarse dispersion liquid decreases, and the fibrous carbon nanostructures are dispersed well. A fluid at a lower pressure (back pressure) than the pressure of the in-flowing coarse dispersion liquid then flows out from the terminal section, yielding the dispersion liquid of the fibrous carbon nanostructures.

The back pressure of the coarse dispersion liquid may be applied to the coarse dispersion liquid by applying a load to the flow of the coarse dispersion liquid. For example, a desired back pressure may be applied to the coarse dispersion liquid by providing a multiple step-down device downstream from the disperser.

With this multiple step-down device, the back pressure of the coarse dispersion liquid is lowered over multiple steps, so that when the dispersion liquid of the fibrous carbon nanostructures is ultimately released into atmospheric pressure, the occurrence of air bubbles in the dispersion liquid can be suppressed.

The disperser may be provided with a heat exchanger or a cooling liquid supply mechanism for cooling the coarse dispersion liquid. The reason is that by cooling the coarse dispersion liquid that is at a high temperature due to the application of a shear force in the disperser, the generation of air bubbles in the coarse dispersion liquid can be further suppressed.

Instead of providing a heat exchanger or the like, the generation of air bubbles in the solvent containing the fibrous carbon nanostructures can also be suppressed by cooling the coarse dispersion liquid in advance.

As described above, in this dispersion treatment that brings about a crushing effect, the occurrence of cavitation can be suppressed, thereby suppressing damage to the fibrous carbon nanostructures due to cavitation, which is sometimes a concern. In particular, damage to the fibrous carbon nanostructures due to shock waves when the air bubbles burst can be suppressed. Additionally, adhesion of air bubbles to the fibrous carbon nanostructures and energy loss due to the generation of air bubbles can be suppressed, and the fibrous carbon nanostructures can also be effectively dispersed evenly.

In particular, as dispersion treatment in the production of the fibrous carbon nanostructure dispersion liquid, dispersion treatment that uses a dispersion treatment device including a thin-tube flow path and transfers the coarse dispersion liquid to the thin-tube flow path to apply shear force to the coarse dispersion liquid and thereby disperse the fibrous carbon nanostructures is preferable. By transferring the coarse dispersion liquid to the thin-tube flow path and applying shear force to the coarse dispersion liquid to disperse the fibrous carbon nanostructures, the fibrous carbon nanostructures can be dispersed favorably while preventing damage to the fibrous carbon nanostructures.

Examples of a dispersion system having the above structure include the product name “BERYU SYSTEM PRO” (manufactured by BeRyu Corporation). Dispersion treatment that brings about a crushing effect may be performed by using such a dispersion system and appropriately controlling the dispersion conditions.

Known additives as described above may be optionally added to the slurry composition obtained in this way, depending on the intended use of the electromagnetic wave absorption material. The mixing time in this case is preferably 10 min or more and 24 hr or less.

—Insulating Material Dispersion Liquid Production Step—

In the slurry composition production step, it is preferable to produce an insulating material dispersion liquid beforehand by adding the above-mentioned insulating material to the above-mentioned solvent and performing dispersion treatment, prior to mixing with the fibrous carbon nanomaterial. The dispersion treatment method may be the above-mentioned typical dispersion method.

In the production of the electromagnetic wave absorption material slurry composition, a resin latex may be used instead of the dispersion liquid obtained by adding the insulating material to the solvent. For example, the resin latex may be obtained by any of the following methods: (1) a method in which a solution of a resin dissolved in an organic solvent is emulsified in water optionally in the presence of a surfactant, and the organic solvent is then removed as necessary to yield the latex; and (2) a method in which a monomer for forming a resin is emulsion polymerized or suspension polymerized to directly yield the latex. An insulating filler may be added to such a resin latex as necessary. The resin may be uncrosslinked or crosslinked. An organic solvent used in the production of the latex is not limited as long as it can be mixed with the fibrous carbon nanostructure dispersion liquid obtained as described above, and may be a typical organic solvent. Although no specific limitations are placed on the solid content concentration in the latex, the concentration is preferably 20 mass % or more and more preferably 60 mass % or more, and more preferably 80 mass % or less, from a viewpoint of achieving homogeneous dispersion in the latex.

<Shaping Step>

The shaping method in the shaping step may be selected as appropriate depending on, for example, the intended use and the type of the insulating material used. Examples of the shaping method include a film formation method by application, and a shaping method to a desired shape.

The electromagnetic wave absorption material and the electromagnetic wave absorber obtained as described below contain the fibrous carbon nanostructures in a state of being approximately uniformly dispersed in a matrix made of the insulating material. The electromagnetic wave absorption material and the electromagnetic wave absorber may be optionally subjected to crosslinking treatment.

[Film Formation Method]

In the shaping step, any known film formation method may be used for film formation (formation) of the electromagnetic wave absorption material in film form (layer form) from the above-mentioned slurry composition. By film-forming the electromagnetic wave absorption material in layer form, an electromagnetic wave absorption layer can be yielded. An electromagnetic wave absorption layer can be obtained by film-forming a material containing fibrous carbon nanostructures and insulating resin.

For example, the slurry composition is applied onto a known film formation substrate that can constitute the above-mentioned insulating layer such as a polyethylene terephthalate (PET) film or a polyimide film and then dried, to remove the solvent from the slurry composition. The application is not limited, and may be performed by a known method such as brush coating or casting. The drying may be performed by a known method such as drying in a vacuum or being left to stand in a draft.

The single-layer electromagnetic wave absorber can be produced through such a film formation method.

—Formation of Multi-Layer Electromagnetic Wave Absorber—

The multi-layer electromagnetic wave absorber can be produced in the following manner.

For example, in the electromagnetic wave absorption material slurry composition production step, a plurality of types of slurry compositions produced in desired blending amounts for multi-layer formation are applied onto a known film formation substrate by a known method. The multi-layer electromagnetic wave absorber can thus be formed. In more detail, for example, one slurry composition is applied onto a PET film constituting an insulating layer and dried to form one electromagnetic wave absorption layer first. After this, another slurry composition is applied onto the electromagnetic wave absorption layer and dried to form another electromagnetic wave absorption layer. Thus, a multi-layer electromagnetic wave absorber including two electromagnetic wave absorption layers and an insulating layer at its outermost layer can be produced. The application and drying methods are not limited, and typical methods as described above may be used.

[Shaping Method to Desired Shape]

It is also possible to shape the electromagnetic wave absorption material which has been made solid through a well-known coagulation method or drying method into a desired shape. Examples of coagulation methods that can coagulate the slurry composition include a method in which the electromagnetic wave absorption material is added to a water-soluble organic solvent, a method in which an acid is added to the electromagnetic wave absorption material, and a method in which salt is added to the electromagnetic wave absorption material. The water-soluble organic solvent is preferably a solvent in which the insulating material in the slurry composition is not dissolved whereas the dispersant is dissolved. Examples of such an organic solvent include methanol, ethanol, 2-propanol, and ethylene glycol. Examples of the acid include acids typically used for latex coagulation, such as acetic acid, formic acid, phosphoric acid, and hydrochloric acid. Examples of the salt include well-known salts typically used for latex coagulation, such as sodium chloride, aluminum sulfate, and potassium chloride.

The electromagnetic wave absorption material obtained by coagulation or drying can be shaped by use of a forming machine suitable for a desired shape of a shaped item, such as a punching machine, an extruder, an injection machine, a compressor, or a roller.

### EXAMPLES

The following provides a more specific description of the present disclosure based on examples. However, the present disclosure is not limited to the following examples. In the following description, “%” and “parts” used in expressing quantities are by mass, unless otherwise specified.

In Examples and Comparative Examples, the following methods were used in order to measure and evaluate the BET specific surface area (m²/g), t-plot, diameter (nm), and amount of oxygen element/amount of nitrogen element at the surfaces of the fibrous carbon nanostructures, the thickness of the electromagnetic wave absorption layer(s) included in the electromagnetic wave absorber, and the reflection attenuation amount (dB) and transmission attenuation amount (dB) of the electromagnetic wave absorber.

<BET Specific Surface Area>

The BET specific surface area of the fibrous carbon nanostructures used in each of Examples and Comparative Examples was measured as follows.

A cell for dedicated use in a fully automated specific surface area analyzer (manufactured by Mountech Co., Ltd., “Macsorb® HM model-1210” (Macsorb is a registered trademark in Japan, other countries, or both)) was thermally treated at 110° C. for 5 hr or more to be sufficiently dried. Into the cell was put 20 mg of fibrous carbon nanostructures measured on a scale. The cell was then placed at a predetermined location of the analyzer, and the BET specific surface area was automatically measured. The analyzer measures a specific surface area on a principle that it finds an adsorption and desorption isotherm of liquid nitrogen at 77K and measures the specific surface area from the adsorption and desorption isotherm according to Brunauer-Emmett-Teller (BET) method.

<t-Plot>

The t-plot of the fibrous carbon nanostructures used in each of Examples and Comparative Examples was measured as follows.

The t-plot was created from the adsorption isotherm obtained in the measurement of the BET specific surface area by converting the relative pressure to an average thickness t (nm) of an adsorbed layer of nitrogen gas. The measurement principle of the t-plot complies with the t-plot method of de Boer et al.

<Diameter of Fibrous Carbon Nanostructure>

First, 0.1 mg of the fibrous carbon nanostructures used in each of Examples and Comparative Examples and 3 mL of ethanol were measured in a 10-mL screw tube bottle on a scale. An ultrasonic cleaner (manufactured by Branson Ultrasonics Corporation, product name “5510J-DTH”) carried out an ultrasonic treatment with respect to the fibrous carbon nanostructures and the ethanol in the screw tube bottle with a vibration output of 180 W at a temperature of 10° C. to 40° C. for 30 min so that the fibrous carbon nanostructures were uniformly dispersed in the ethanol. A dispersion liquid was thus obtained. Then, 50 μL of the obtained dispersion liquid was dropped on a micro grid (manufactured by Okenshoji Co., Ltd., product name “Micro Grid Type A STEM 150 Cu grid”) for use in a transmission electron microscope, left to stand for 1 hr or more, and then dried in a vacuum at 25° C. for 5 hr or more, to cause the fibrous carbon nanostructures to be held by the micro grid. The micro grid was then placed on a transmission electron microscope (manufactured by Topcon Technohouse Corporation, product name “EM-002B”). The fibrous carbon nanostructures were observed at 1.5 million magnifications.

The fibrous carbon nanostructures were observed at ten random places of the micro grid. Ten fibrous carbon nanostructures were selected at random at each of the ten random places, and the diameter of each of the fibrous carbon nanostructures in the direction in which the diameter was minimum was measured. An average value of measured diameters of 100 fibrous carbon nanostructures was found as the number average diameter of the fibrous carbon nanostructures.

<Amount of Oxygen Element/Amount of Nitrogen Element at Fibrous Carbon Nanostructure Surfaces>

For the fibrous carbon nanostructures used in each of Examples and Comparative Examples, each of the amount of the oxygen element and the amount of the nitrogen element relative to the amount of the carbon element was calculated. Fibrous carbon nanostructures were fixed to a carbon double sided tape, to produce a test piece. The test piece was irradiated with 150 W (acceleration voltage 15 kV, current value 10 mA) AlKα monochromator X rays by an X-ray photoelectron spectrometer (XPS, manufactured by KRATOS Co., “AXIS ULTRA DLD”). At angle θ 90° of the sample surface with the detector direction, a wide spectrum was measured for qualitative analysis, and then a narrow spectrum of each element was measured for quantitative analysis. With use of an analysis application (manufactured by KRATOS Co., “Vision Processing”), a peak area was integrated from the obtained spectra. After correction using an element-specific sensitivity coefficient, how many times each of the amount of the oxygen element and the amount of the nitrogen element was relative to the amount of the carbon element was calculated.

<Thickness of Electromagnetic Wave Absorption Layer>

A micrometer (manufactured by Mitutoyo Corporation, 293 series, “MDH-25”) was used to measure thickness at ten points for the electromagnetic wave absorber produced in each of Examples and Comparative Examples, and the thickness 38 μm of the PET film (forming the insulating layer) used as a substrate was subtracted from an average value of the measurements, to determine the thickness of the electromagnetic wave absorption layer.

<Electromagnetic Wave Absorption Performance of Electromagnetic Wave Absorber>

The electromagnetic wave absorption performance of the electromagnetic wave absorber was evaluated by measuring the electromagnetic wave reflection attenuation amount (dB).

The electromagnetic wave absorber produced in each of Examples and Comparative Examples was attached, as a specimen, to a conductive metal plate so that the electromagnetic wave absorber layer side higher in carbon material concentration faced the conductive metal plate. In other words, the electromagnetic wave absorber was placed so that an electromagnetic wave was incident on the insulating layer side of the electromagnetic wave absorber when attaching the conductive metal plate to a measurement system.

A measurement system (manufactured by KEYCOM Co., Ltd., “DPS10”) was used to measure S (Scattering) parameter (S11) with one port by the free space method. The measurement was performed for frequencies of 60 GHz to 90 GHz. As the measurement system, a vector network analyzer (manufactured by Anritsu Corporation, “ME7838A”) and an antenna (part number “RH15S10” and “RH10S10”) were employed. Table 1 shows the results (absolute values) of calculating the reflection attenuation amount (dB) according to the following Formula (1) based on S parameter (S11) when irradiating an electromagnetic wave of 60 GHz and 76 GHz. A higher reflection attenuation amount indicates better electromagnetic wave absorption performance.

Reflection attenuation amount (dB)=20 log|S11| (1).

<Electromagnetic Wave Shield Performance of Electromagnetic Wave Absorber>

The electromagnetic wave shield performance of the electromagnetic wave absorber was evaluated by measuring the electromagnetic wave transmission attenuation amount (dB).

The transmission attenuation amount of the electromagnetic wave absorber produced in each of Examples and Comparative Examples was calculated as follows: Under the same test conditions as the above-mentioned reflection attenuation amount measurement except that the electromagnetic wave absorber was installed in the measurement system by the free space method without being attached to a conductive metal plate, S21 parameter was measured, and the transmission attenuation amount (dB) was calculated according to the following Formula (2). A higher transmission attenuation amount indicates better electromagnetic wave shield performance.

The electromagnetic wave shield performance means shield performance by reflecting and absorbing an electromagnetic wave. Thus, the electromagnetic wave shield performance is different from electromagnetic wave absorption performance that represents a property of removing an electromagnetic wave by absorbing the electromagnetic wave and converting it into heat energy.

Transmission attenuation amount (dB)=20 log|S21| (2).

### Example 1

### <Production of Electromagnetic Wave Absorption Material>

### [Production of Fibrous Carbon Nanostructures]

Single-walled carbon nanotubes (hereafter also referred to as “SWCNTs”) obtained by the super growth method described in JP 4,621,896 B2 were taken to be fibrous carbon nanostructures as a carbon material. Specifically, SWCNTs were synthesized on the following conditions:

Carbon compound: ethylene (feeding rate: 50 sccm) Atmosphere (gas) (Pa): mixed gas of helium and hydrogen (feeding rate: 1000 sccm)

Pressure: 1 atmospheric pressure

Amount of water vapor added (ppm): 300 ppm

Reaction temperature (° C.): 750° C.

Reaction time (min): 10 min

Metal catalyst (amount of presence): iron thin film (thickness: 1 nm)

Substrate: silicon wafer.

The obtained SWCNTs were subjected to each of the measurements mentioned above. The results are shown in Table 1. Upon measuring with a Raman spectrometer, spectra of a Radial Breathing Mode (RBM) were observed in a low-wavenumber region of 100 cm⁻¹ to 300 cm⁻¹, which is characteristic of single-walled carbon nanotubes. Through observation under a transmission electron microscope, it was confirmed that 99% or more were single-walled carbon nanotubes. According to the foregoing method, a number average diameter of 3.3 nm was measured, and a length of 100 μm or more was found.

[Fibrous Carbon Nanostructure Surface Treatment]

—Plasma treatment—

The synthesized SWCNTs were then treated for 0.5 hr under conditions of pressure: 40 Pa, power: 200 W (energy output per unit area: 1.28 W/cm²), rotational speed: 30 rpm, and air introduction, using a gas introducible vacuum plasma apparatus (manufactured by SAKIGAKE-Semiconductor Co., Ltd., “YHS-DΦS”). How many times each of the amount of the oxygen element and the amount of the nitrogen element was relative to the amount of the carbon element at the surfaces of the surface-treated SWCNTs was evaluated. The results are shown in Table 1.

[Production of Electromagnetic Wave Absorption Material Slurry Composition]

### —CNT Dispersion Liquid Production Step—

The surface-treated SWCNTs produced as described above were added to methyl ethyl ketone as an organic solvent so as to have a concentration of 0.2%, and stirred with a magnetic stirrer for 24 hr to obtain a preliminary dispersion liquid of the surface-treated SWCNTs.

Next, the preliminary dispersion liquid was charged into a multistage step-down high-pressure homogenizer (manufactured by Beryu Corporation, product name “BERYU SYSTEM PRO”) having a multistage pressure controller (multistage step-down transformer) connected to a high-pressure dispersion treatment portion (jet mill) having a thin-tube flow path portion with a diameter of 200 μm, and a pressure of 120 MPa was applied to the preliminary dispersion liquid intermittently and instantaneously, to transfer the preliminary dispersion liquid into the thin-tube flow path and disperse it. A surface-treated SWCNT dispersion liquid was thus obtained.

### —Mixing Step—

Apart from the CNT dispersion liquid, fluororubber (manufactured by DuPont, “Viton GBL200S”) as an insulating material was added to methyl ethyl ketone as an organic solvent so as to have a concentration of 2%, and stirred to dissolve the fluororubber, thus obtaining an insulating material solution.

The insulating material solution and the CNT dispersion liquid were mixed so that the blending amount ratio of the fluororubber as the insulating material and the surface-treated SWCNTs as the fibrous carbon nanostructures was 100 parts:1 parts in solid content ratio, to produce an electromagnetic wave absorption material slurry composition.

<Production of Electromagnetic Wave Absorber>

Next, an electromagnetic wave absorption sheet as an electromagnetic wave absorption material structure was formed. The electromagnetic wave absorption material slurry composition containing the surface-treated SWCNTs was applied to a polyimide film (manufactured by DuPont-Toray Co., Ltd., “Kapton® 100H Type” (Kapton is a registered trademark in Japan, other countries, or both), thickness: 25 μm) which was a film formation substrate as an insulating layer. After this, natural drying was performed at 25° C. for 1 week or more in a draft of a constant-temperature environment including a local exhaust ventilation system, to obtain an electromagnetic wave absorber. The resultant electromagnetic wave absorber included an insulating layer containing polyimide as an insulating material for an insulating layer, and an electromagnetic wave absorption layer containing surface-treated SWCNTs. Such an electromagnetic wave absorber was subjected to the measurements according to the above-mentioned methods. The results are shown in Table 1. The results of measuring the transmission attenuation amount for the electromagnetic wave absorber by the above-mentioned method were 9.2 dB at 60 GHz and 8.9 dB at 76 GHz.

### Example 2

A slurry composition was produced in the same way as in Example 1, except that the SWCNT surface treatment time was 2 hr, uncrosslinked hydrogenated acrylonitrile butadiene rubber (HNBR, manufactured by Zeon Corporation, “Zetpol 2001”) was used as the insulating material of the electromagnetic wave absorption layer instead of fluororubber, and the blending amount ratio of the HNBR as the insulating material and the surface-treated SWCNTs as the fibrous carbon nanostructures was changed as shown in Table 1. Using such a slurry composition, an electromagnetic wave absorber having an electromagnetic wave absorption layer with the layer thickness in Table 1 was produced and subjected to the measurements in the same way as in Example 1. The results are shown in Table 1. The results of measuring the transmission attenuation amount for the electromagnetic wave absorber by the above-mentioned method were 9.4 dB at 60 GHz and 9.3 dB at 76 GHz.

### Example 3

A slurry composition was produced in the same way as in Example 1, except that the SWCNT surface treatment was performed under a nitrogen introduction condition, uncrosslinked acrylonitrile butadiene rubber (NBR, manufactured by Zeon Corporation, “Nipol DN3350”) was used as the insulating material of the electromagnetic wave absorption layer instead of fluororubber, and the blending amount ratio of the NBR as the insulating material and the surface-treated SWCNTs as the fibrous carbon nanostructures was changed as shown in Table 1. Using such a slurry composition, an electromagnetic wave absorber having an electromagnetic wave absorption layer with the layer thickness in Table 1 was produced and subjected to the measurements in the same way as in Example 1. The results are shown in Table 1. The results of measuring the transmission attenuation amount for the electromagnetic wave absorber by the above-mentioned method were 8.9 dB at 60 GHz and 8.8 dB at 76 GHz.

### Example 4

A slurry composition was produced in the same way as in Example 1, except that the SWCNT surface treatment was performed under a nitrogen introduction condition, the surface treatment time was changed to 2 hr, uncrosslinked acrylic rubber (manufactured by Zeon Corporation, “Nipol AR12”) was used as the insulating material of the electromagnetic wave absorption layer instead of fluororubber, and the blending amount ratio of the acrylic rubber as the insulating material and the surface-treated SWCNTs as the fibrous carbon nanostructures was changed as shown in Table 1. Using such a slurry composition, an electromagnetic wave absorber having an electromagnetic wave absorption layer with the layer thickness in Table 1 was produced and subjected to the measurements in the same way as in Example 1. The results are shown in Table 1. The results of measuring the transmission attenuation amount for the electromagnetic wave absorber by the above-mentioned method were 11 dB at 60 GHz and 10 dB at 76 GHz.

### Example 5

A slurry composition produced in the same way as in Example 1 was put into a container equipped with a stirrer, and the organic solvent was sufficiently volatilized by natural drying while stirring, to obtain a solid electromagnetic wave absorption material. The solid electromagnetic wave absorption material was taken out of the container, and dried in a vacuum at 60° C. for 24 hr or more, thus obtaining an electromagnetic wave absorption material. The obtained electromagnetic wave absorption material was sandwiched between mirror-finished metal plates, and subjected to vacuum compression forming at a temperature of 120° C. in a vacuum compression molding machine. Thus, an electromagnetic wave absorber with a thickness of 500 μm including an electromagnetic wave absorption layer containing surface-treated SWCNTs as a fibrous carbon nanomaterial according to the present disclosure was formed. The obtained electromagnetic wave absorber was subjected to the measurements in the same way as in Example 1. The results are shown in Table 1. The results of measuring the transmission attenuation amount for the electromagnetic wave absorber by the above-mentioned method were 11 dB at 60 GHz and 11 dB at 76 GHz.

### Example 6

SWCNT surface treatment was performed by ozone treatment described in detail below. As the insulating material for the electromagnetic wave absorption layer, 90 parts of fluororubber (manufactured by DuPont, “Viton GBL200S”) and 10 parts of silica (manufactured by Tosoh Silica Corporation, “Nipsil UN3”) were used. Surface-treated SWCNTs obtained as a result of the ozone treatment were used to obtain a surface-treated SWCNTs dispersion liquid in the same way as in Example 1. When mixing the surface-treated SWCNTs dispersion liquid and the insulating material, first, an insulating material solution in which fluororubber was dissolved was obtained and mixed with the surface-treated SWCNTs dispersion liquid in the same way as in Example 1. Silica was added to the resultant mixed solution at the above-mentioned blending ratio, thus producing an electromagnetic wave absorption material slurry composition. The blending amount ratio of the insulating material containing fluororubber and silica and the surface-treated SWCNTs as the fibrous carbon nanostructures is as shown in Table 1. Using such a slurry composition, an electromagnetic wave absorber having an electromagnetic wave absorption layer with the layer thickness in Table 1 was produced and subjected to the measurements in the same way as in Example 1. The results are shown in Table 1. The results of measuring the transmission attenuation amount for the electromagnetic wave absorber by the above-mentioned method were 7.9 dB at 60 GHz and 6.9 dB at 76 GHz.

[Fibrous Carbon Nanostructure Surface Treatment]

### —Ozone Treatment—

For SWCNTs obtained in the same way as in Example 1, a dispersion liquid having methyl ethyl ketone as a solvent was produced, and placed in a treatment vessel of an ozone generator (manufactured by Asahi Techniglass Co., Ltd., “LABO OZON-250”). The SWCNT dispersion liquid was then treated for 4.0 hr while stirring it, with a temperature of 25° C. and an ozone concentration of 0.65 mg/l in the treatment vessel. The surface characteristics of the resultant surface-treated SWCNTs were measured in the same way as in Example 1. The results are shown in Table 1.

### Examples 7 to 8

A slurry composition was produced in the same way as in Example 6, except that the ozone treatment time, the insulating material, and the blending amount ratio of the insulating material and the surface-treated SWCNTs as the fibrous carbon nanostructures were changed as shown in Table 1. Using such a slurry composition, an electromagnetic wave absorber having an electromagnetic wave absorption layer with the layer thickness in Table 1 was produced and subjected to the measurements in the same way as in Example 1. The results are shown in Table 1. The results of measuring the transmission attenuation amount for the electromagnetic wave absorber by the above-mentioned method were 7.9 dB at 60 GHz and 7.8 dB at 76 GHz in Example 7, and 10 dB at 60 GHz and 10 dB at 76 GHz in Example 8.

In Example 7, polycarbonate (PC) (manufactured by Idemitsu Kosan Co., Ltd., “TARFLON A1900”) was used as the insulating material, and chloroform was used as the solvent.

In Example 8, a mixed material of 90 parts of polycarbonate (PC) (manufactured by Idemitsu Kosan Co. Ltd., “TARFLON A1900”) and 10 parts of silica (manufactured by Tosoh Silica Corporation, “Nipsil UN3”) was used as the insulating material, and chloroform was used as the solvent.

### Examples 9 to 10

A slurry composition was produced in the same way as in Example 6, except that multi-walled carbon nanotubes (MWCNTs) (manufactured by Nanocyl SA, “NC7000”, number average length: 1.5 μm, BET specific surface area: 265 m²/g, t-plot: convex downward) were used as the fibrous carbon nanostructures, and the ozone treatment time, the insulating material, and the blending amount ratio of the insulating material and the surface-treated SWCNTs as the fibrous carbon nanostructures were changed as shown in Table 1. Using such a slurry composition, an electromagnetic wave absorber having an electromagnetic wave absorption layer with the layer thickness in Table 1 was produced and subjected to the measurements in the same way as in Example 1. The results are shown in Table 1. The results of measuring the transmission attenuation amount for the electromagnetic wave absorber by the above-mentioned method were 8.6 dB at 60 GHz and 8.1 dB at 76 GHz in Example 9, and 10 dB at 60 GHz and 9.9 dB at 76 GHz in Example 10.

Upon measuring with a Raman spectrometer, spectra of a Radial Breathing Mode (RBM) were not observed in a low-wavenumber region of 100 cm⁻¹ to 300 cm⁻¹, which is characteristic of single-walled carbon nanotubes. Through observation under a transmission electron microscope as in Example 1, it was confirmed that 99% or more were multi-walled CNTs, and the number average diameter was 10.1 nm.

### Example 11

A slurry composition was produced in the same way as in Example 3, except that mixed carbon nanotubes (mixed CNTs) of SWCNTs: 60% and MWCNTs: 40% were used as the fibrous carbon nanostructures. Using such a slurry composition, an electromagnetic wave absorber having an electromagnetic wave absorption layer with the layer thickness in Table 1 was produced and subjected to the measurements in the same way as in Example 1. The results are shown in Table 1. The results of measuring the transmission attenuation amount for the electromagnetic wave absorber by the above-mentioned method were 6.9 dB at 60 GHz and 6.8 dB at 76 GHz.

The properties of the mixed CNTs measured in the same way as in Example 1 are also shown in Table 1.

### Example 12

### <Production of Electromagnetic Wave Absorber>

A multi-layer electromagnetic wave absorber was produced as an electromagnetic wave absorber. Herein, to distinguish the slurry compositions used in the formation of the respective electromagnetic wave absorption layers of the multi-layer electromagnetic wave absorber, a slurry composition produced in the same way as in Example 2 is referred to as “first slurry composition”. A second slurry composition was produced in the same way as in Example 2, except that the blending amount ratio of the HNBR as the insulating material and the surface-treated SWCNTs as the fibrous carbon nanostructures was changed to 100 parts:1 parts.

When producing an electromagnetic wave absorber using the first and second slurry compositions, first, the second slurry composition was applied to a polyimide film (manufactured by DuPont-Toray Co., Ltd., “Kapton® 100H Type”, thickness: 25 μm) which was a film formation substrate as an insulating layer. After this, natural drying was performed at 25° C. for 1 week or more in a draft of a constant-temperature environment including a local exhaust ventilation system, to sufficiently volatilize the organic solvent. The thickness of an electromagnetic wave absorption layer (hereafter also referred to as “second electromagnetic wave absorption layer”) formed using the second slurry composition was measured by the above-mentioned measurement method. The results are shown in Table 1.

In the same manner as above, an electromagnetic wave absorption layer (hereafter also referred to as “first electromagnetic wave absorption layer”) was formed on the second electromagnetic wave absorption layer using the first slurry composition. For the resultant electromagnetic wave absorber having the insulating layer, the second electromagnetic wave absorption layer, and the first electromagnetic wave absorption layer adjacent to each other, the thickness of the electromagnetic wave absorption layer was measured approximately in the same way as the above-mentioned measurement method. The thicknesses of the insulating layer and the second electromagnetic wave absorption layer were subtracted from the total thickness of the electromagnetic wave absorber, to obtain the thickness of the first electromagnetic wave absorption layer.

The obtained electromagnetic wave absorber was subjected to each of the measurements mentioned above. The results are shown in Table 1. The results of measuring the transmission attenuation amount for the electromagnetic wave absorber by the above-mentioned method were 15 dB at 60 GHz and 14 dB at 76 GHz.

### Example 13

A multi-layer electromagnetic wave absorber was produced as an electromagnetic wave absorber. Herein, to distinguish the slurry compositions used in the formation of the respective electromagnetic wave absorption layers of the multi-layer electromagnetic wave absorber, a slurry composition produced in the same way as in Example 4 is referred to as “first slurry composition”. A second slurry composition was produced in the same way as in Example 4, except that the blending amount ratio of the acrylic rubber as the insulating material and the surface-treated SWCNTs as the fibrous carbon nanostructures was changed to 100 parts:1 parts.

A multi-layer electromagnetic wave absorber was produced using the first and second slurry compositions in the same way as in Example 12. The multi-layer electromagnetic wave absorber was then measured in the same way as in Example 12. The results are shown in Table 1. The results of measuring the transmission attenuation amount for the electromagnetic wave absorber by the above-mentioned method were 16 dB at 60 GHz and 16 dB at 76 GHz.

### Comparative Example 1

A slurry composition was produced in the same way as in Example 1, except that SWCNTs synthesized in the same way as in Example 1 were used without surface treatment, and the blending amount ratio of the fluororubber as the insulating material and the CNTs as the fibrous carbon nanostructures was changed as shown in Table 1. Using such a slurry composition, an electromagnetic wave absorber having an electromagnetic wave absorption layer with the layer thickness in Table 1 was produced and subjected to the measurements in the same way as in Example 1. The results are shown in Table 1. The results of measuring the transmission attenuation amount for the electromagnetic wave absorber by the above-mentioned method were 21 dB at 60 GHz and 20 dB at 76 GHz.

### Comparative Example 2

A slurry composition was produced in the same way as in Example 5, except that SWCNTs synthesized in the same way as in Example 1 were used without surface treatment. Using such a slurry composition, an electromagnetic wave absorber having an electromagnetic wave absorption layer with the layer thickness in Table 1 was produced and subjected to the measurements in the same way as in Example 1. The results are shown in Table 1. The results of measuring the transmission attenuation amount for the electromagnetic wave absorber by the above-mentioned method were 13 dB at 60 GHz and 13 dB at 76 GHz.

### Comparative Example 3

A slurry composition was produced in the same way as in Example 10, except that multi-walled carbon nanotubes (MWCNTs) (manufactured by Nanocyl SA, “NC7000”, number average length: 1.5 μm, BET specific surface area: 265 m²/g, t-plot: convex downward) were used as the fibrous carbon nanostructures, and ozone treatment was not performed. Using such a slurry composition, an electromagnetic wave absorber having an electromagnetic wave absorption layer with the layer thickness in Table 1 was produced and subjected to the measurements in the same way as in Example 1. The results are shown in Table 1. The results of measuring the transmission attenuation amount for the electromagnetic wave absorber by the above-mentioned method were 12 dB at 60 GHz and 11 dB at 76 GHz.

### Comparative Example 4

A slurry composition was produced in the same way as in Example 1, except that milled carbon fibers (manufactured by Nippon Polymer Sangyo Co. Ltd., “CFMP-30X”, average fiber length: 40 μm, average fiber diameter: 7 μm) which were not surface-treated were used as the carbon material instead of the fibrous carbon nanostructures, and the blending amount ratio of the fluororubber as the insulating material and the carbon material was changed as shown in Table 1. Using such a slurry composition, an electromagnetic wave absorber having an electromagnetic wave absorption layer with the layer thickness in Table 1 was produced and subjected to the measurements in the same way as in Example 1. The results are shown in Table 1. The results of measuring the transmission attenuation amount for the electromagnetic wave absorber by the above-mentioned method were 5.0 dB at 60 GHz and 4.9 dB at 76 GHz.

The properties of the milled carbon fibers measured in the same way as in Example 1 are also shown in Table 1.

In the table, “SWCNT” denotes single-walled carbon nanotubes, “MWCNT” denotes multi-walled carbon nanotubes, “HNBR” denotes hydrogenated acrylonitrile butadiene rubber, “NBR” denotes acrylonitrile butadiene rubber, and “PC” denotes polycarbonate.

TABLE 1

| | | | | Example 1 | Example 2 | Example 3 | Example 4 | Example 5 | Example 6 |
|---|---|---|---|---|---|---|---|---|---|
| Surface- | Before | Carbon material | | SWCNT | SWCNT | SWCNT | SWCNT | SWCNT | SWCNT |
| treated | treatment | | | | | | | | |
| carbon | | Specific surface area [m²/g] | | 880 | 880 | 880 | 880 | 880 | 880 |
| structure | | t-plot | | Convex | Convex | Convex | Convex | Convex | Convex |
| | | | | upward | upward | upward | upward | upward | upward |
| | | Diameter [nm] | | 3.3 | 3.3 | 3.3 | 3.3 | 3.3 | 3.3 |
| | After | Surface treatment method | | Atmospheric | Atmospheric | Nitrogen | Nitrogen | Atmospheric | Ozone |
| | treatment | | | discharge | discharge | discharge | discharge | discharge | treatment |
| | | | | plasma | plasma | plasma | plasma | plasma | |
| | | Treatment time [hr] | | 0.5 | 2 | 0.5 | 2 | 0.5 | 4 |
| | | Amount of oxygen element | | 0.187 | 0.295 | 0.083 | 0.221 | 0.187 | 0.071 |
| | | [times]*¹ | | | | | | | |
| | | Amount of nitrogen element | | 0.010 | 0.019 | 0.027 | 0.103 | 0.010 | 0 |
| | | [times]*¹ | | | | | | | |
| E- | Insulating layer | | Insulating material for | Polyimide | Polyimide | Polyimide | Polyimide | — | Polyimide |
| lectromagnetic | | | insulating layer | | | | | | |
| wave | | | Layer thickness (μm) | 25 | 25 | 25 | 25 | — | 25 |
| absorber | Electromagnetic | Second | Blending amount of | — | — | — | — | — | — |
| | wave | layer | surface-treated | | | | | | |
| | absorption | | carbon material | | | | | | |
| | layer | | [parts by mass]*² | | | | | | |
| | | | Layer thickness (μm) | — | — | — | — | — | — |
| | | First | Blending amount of | 1 | 2 | 1 | 2 | 1 | 0.8 |
| | | layer | surface-treated | | | | | | |
| | | | carbon material | | | | | | |
| | | | [parts by mass]*² | | | | | | |
| | | | Layer thickness (μm) | 33 | 45 | 28 | 52 | 500 | 86 |

| | | | | | | |
|---|---|---|---|---|---|---|
| Insulating material for | Fluoro- | HNBR | NBR | Acrylic | Fluoro- | Silica/ |
| electromagnetic | rubber | | | rubber | rubber | Fluororubber |
| wave absorption layer | | | | | | |

| | | | | | | | | |
|---|---|---|---|---|---|---|---|---|
| Evaluation | Reflection | Reflection attenuation | 25 dB | 29 dB | 24 dB | 30 dB | 18 dB | 20 dB |
| | attenuation | amount: 60 GHz | | | | | | |
| | amount [dB] | Reflection attenuation | 16 dB | 19 dB | 17 dB | 20 dB | 13 dB | 12 dB |
| | | amount: 76 GHz | | | | | | |

| | | | | Example 7 | Example 8 | Example 9 | Example 10 | Example 11 | Example 12 |
|---|---|---|---|---|---|---|---|---|---|
| Surface- | Before | Carbon material | | SWCNT | SWCNT | MWCNT | MWCNT | SWCNT: 60 | SWCNT |
| treated | treatment | | | | | | | MWCNT: 40 | |
| carbon | | Specific surface area [m²/g] | | 880 | 880 | 265 | 265 | 620 | 880 |
| structure | | t-plot | | Convex | Convex | Convex | Convex | Convex | Convex |
| | | | | upward | upward | downward | downward | upward | upward |
| | | Diameter [nm] | | 3.3 | 3.3 | 10.1 | 10.1 | 3.3 | 3.3 |
| | After | Surface treatment method | | Ozone | Ozone | Ozone | Ozone | Nitrogen | Atmospheric |
| | treatment | | | treatment | treatment | treatment | treatment | discharge | discharge |
| | | | | | | | | plasma | plasma |
| | | Treatment time [hr] | | 24 | 48 | 24 | 48 | 0.5 | 2 |
| | | Amount of oxygen element | | 0.171 | 0.179 | 0.068 | 0.099 | 0.069 | 0.295 |
| | | [times]*¹ | | | | | | | |
| | | Amount of nitrogen element | | 0 | 0 | 0 | 0 | 0.018 | 0.019 |
| | | [times]*¹ | | | | | | | |
| E- | Insulating layer | | Insulating material for | Polyimide | Polyimide | Polyimide | Polyimide | Polyimide | Polyimide |
| lectromagnetic | | | insulating layer | | | | | | |
| wave | | | Layer thickness (μm) | 25 | 25 | 25 | 25 | 25 | 25 |
| absorber | Electromagnetic | Second | Blending amount of | — | — | — | — | — | 1 |
| | wave | layer | surface-treated | | | | | | |
| | absorption | | carbon material | | | | | | |
| | layer | | [parts by mass]*² | | | | | | |
| | | | Layer thickness (μm) | — | — | — | — | — | 33 |
| | | First | Blending amount of | 1 | 3 | 5 | 10 | 1 | 2 |
| | | layer | surface-treated | | | | | | |
| | | | carbon material | | | | | | |
| | | | [parts by mass]*² | | | | | | |
| | | | Layer thickness (μm) | 55 | 98 | 60 | 100 | 77 | 32 |

| | | | | | | |
|---|---|---|---|---|---|---|
| Insulating material for | PC | Silica/PC | Fluoro- | Fluoro- | NBR | HNBR |
| electromagnetic | | | rubber | rubber | | |
| wave absorption layer | | | | | | |

| | | | | | | | | |
|---|---|---|---|---|---|---|---|---|
| Evaluation | Reflection | Reflection attenuation | 23 dB | 28 dB | 23 dB | 20 dB | 19 dB | 31 dB |
| | attenuation | amount: 60 GHz | | | | | | |
| | amount [dB] | Reflection attenuation | 15 dB | 18 dB | 15 dB | 16 dB | 14 dB | 21 dB |
| | | amount: 76 GHz | | | | | | |

| | | | | | Comparative | Comparative | Comparative | Comparative |
|---|---|---|---|---|---|---|---|---|
| | | | | Example 13 | Example 1 | Example 2 | Example 3 | Example 4 |
| Surface- | Before | Carbon material | | SWCNT | SWCNT | SWCNT | MWCNT | Carbon |
| treated | treatment | | | | | | | fiber |
| carbon | | Specific surface area [m²/g] | | 880 | 880 | 880 | 265 | 110 |
| structure | | t-plot | | Convex | Convex | Convex | Convex | Convex |
| | | | | upward | upward | upward | downward | downward |
| | | Diameter [nm] | | 3.3 | 3.3 | 3.3 | 10.1 | 4.9 μm |
| | After | Surface treatment method | | Nitrogen | No | No | No | No |
| | treatment | | | discharge | treatment | treatment | treatment | treatment |
| | | | | plasma | | | | |
| | | Treatment time [hr] | | 2 | — | — | — | — |
| | | Amount of oxygen element | | 0.221 | 0.013 | 0.013 | 0.003 | 0 |
| | | [times]*¹ | | | | | | |
| | | Amount of nitrogen element | | 0.103 | 0 | 0 | 0 | 0 |
| | | [times]*¹ | | | | | | |
| E- | Insulating layer | | Insulating material for | Polyimide | Polyimide | — | Polyimide | Polyimide |
| lectromagnetic | | | insulating layer | | | | | |
| wave | | | Layer thickness (μm) | 25 | 25 | — | 25 | 25 |
| absorber | Electromagnetic | Second | Blending amount of | 1 | — | — | — | — |
| | wave | layer | surface-treated | | | | | |
| | absorption | | carbon material | | | | | |
| | layer | | [parts by mass]*² | | | | | |
| | | | Layer thickness (μm) | 34 | — | — | — | — |
| | | First | Blending amount of | 2 | 5 | 1 | 10 | 20 |
| | | layer | surface-treated | | | | | |
| | | | carbon material | | | | | |
| | | | [parts by mass]*² | | | | | |
| | | | Layer thickness (μm) | 30 | 30 | 500 | 150 | 55 |

| | | | | | |
|---|---|---|---|---|---|
| Insulating material for | Acrylic | Fluoro- | Fluoro- | Fluoro- | Fluoro- |
| electromagnetic | rubber | rubber | rubber | rubber | rubber |
| wave absorption layer | | | | | |

| | | | | | | | |
|---|---|---|---|---|---|---|---|
| Evaluation | Reflection | Reflection attenuation | 32 dB | 1.2 dB | 6.0 dB | 8.8 dB | 6.0 dB |
| | attenuation | amount: 60 GHz | | | | | |
| | amount [dB] | Reflection attenuation | 22 dB | 1.1 dB | 5.0 dB | 9.9 dB | 5.1 dB |
| | | amount: 76 GHz | | | | | |

*¹relative to amount of carbon [symbol]
*²relative to 100 parts by mass of insulating material for electromag [symbol] [symbol]
indicates data missing or illegible when filed

The electromagnetic wave absorbers of Examples 1 to 13 each include at least one electromagnetic wave absorption layer formed using the presently disclosed electromagnetic wave absorption material that contains surface-treated fibrous carbon nanostructures and in which the amount of the oxygen element is 0.030 times or more and 0.300 times or less the amount of the carbon element and/or the amount of the nitrogen element is 0.005 times or more and 0.200 times or less the amount of the carbon element at the surfaces of the surface-treated fibrous carbon nanostructures. As is clear from Table 1, the electromagnetic wave absorbers of Examples 1 to 13 had a reflection attenuation amount of 10 dB or more for an electromagnetic wave at 60 GHz and 76 GHz. This demonstrates that an electromagnetic wave absorber including an electromagnetic wave absorption layer formed using the presently disclosed electromagnetic wave absorption material had sufficiently high electromagnetic wave absorption capacity in a high frequency domain of more than 20 GHz. On the other hand, the electromagnetic wave absorbers of Comparative Examples 1 to 4 including fibrous carbon nanostructures at the surfaces of which the amount of the oxygen element and the amount of the nitrogen element are outside the presently disclosed range had insufficient electromagnetic wave absorption capacity in a high frequency domain of more than 20 GHz.

### INDUSTRIAL APPLICABILITY

It is thus possible to provide an electromagnetic wave absorption material and an electromagnetic wave absorber capable of absorbing an electromagnetic wave of a high frequency domain of more than 20 GHz, and production methods therefor.

1. An electromagnetic wave absorption material, comprising
surface-treated fibrous carbon nanostructures obtainable by treating surfaces of fibrous carbon nanostructures,
wherein at surfaces of the surface-treated fibrous carbon nanostructures, an amount of an oxygen element is 0.030 times or more and 0.300 times or less an amount of a carbon element and/or an amount of a nitrogen element is 0.005 times or more and 0.200 times or less the amount of the carbon element.

2. The electromagnetic wave absorption material according to claim 1,
wherein at the surfaces of the surface-treated fibrous carbon nanostructures, the amount of the oxygen element is 0.030 times or more and 0.300 times or less the amount of the carbon element and the amount of the nitrogen element is 0.005 times or more and 0.200 times or less the amount of the carbon element.

3. The electromagnetic wave absorption material according to claim 1,
wherein a BET specific surface area of the fibrous carbon nanostructures is 200 m²/g or more.

4. The electromagnetic wave absorption material according to claim 1,
wherein a t-plot of the fibrous carbon nanostructures is convex upward.

5. The electromagnetic wave absorption material according to claim 1,
wherein a number average diameter of the fibrous carbon nanostructures is 15 nm or less.

6. The electromagnetic wave absorption material according to claim 1,
wherein the fibrous carbon nanostructures include single-walled carbon nanotubes and multi-walled carbon nanotubes, and
a content of the single-walled carbon nanotubes is 50 mass % or more in the case where a whole content of the fibrous carbon nanostructures is 100 mass %.

7. The electromagnetic wave absorption material according to claim 1, further comprising
an insulating material,
wherein a content A of the surface-treated fibrous carbon nanostructures is 0.5 parts by mass or more and 15 parts by mass or less in the case where a content of the insulating material is 100 parts by mass.

8. The electromagnetic wave absorption material according to claim 7,
wherein the insulating material is insulating resin.

9. An electromagnetic wave absorber, comprising
an electromagnetic wave absorption layer formed using the electromagnetic wave absorption material according to claim 1.

10. An electromagnetic wave absorber, comprising
a plurality of electromagnetic wave absorption layers each including surface-treated fibrous carbon nanostructures and an insulating material,
wherein surface-treated fibrous carbon nanostructures and/or insulating materials included in the respective plurality of electromagnetic wave absorption layers are of a same type or different types,
in the case where the plurality of electromagnetic wave absorption layers are denoted as a first electromagnetic wave absorption layer, a second electromagnetic wave absorption layer, . . . , and an nth electromagnetic wave absorption layer from a side farther from an electromagnetic wave incidence side and contents of the surface-treated fibrous carbon nanostructures in the respective plurality of electromagnetic wave absorption layers are denoted as A1 parts by mass, A2 parts by mass, . . . , and An parts by mass where a content of the insulating material in a corresponding electromagnetic wave absorption layer is 100 parts by mass, the following formulas (1) and any of (2) and (3) hold true:
0.5≤A1≤15 (1)
A1>A2, when n is 2 (2)
A1>A2≥ . . . ≥An, when n is a natural number of 3 or more (3),
the first electromagnetic wave absorption layer from among all of the plurality of electromagnetic wave absorption layers has a highest content of surface-treated fibrous carbon nanostructures, and
at surfaces of the surface-treated fibrous carbon nanostructures, an amount of an oxygen element is 0.030 times or more and 0.300 times or less an amount of a carbon element and/or an amount of a nitrogen element is 0.005 times or more and 0.200 times or less the amount of the carbon element.

11. The electromagnetic wave absorber according to claim 10,
wherein at the surfaces of the surface-treated fibrous carbon nanostructures, the amount of the oxygen element is 0.030 times or more and 0.300 times or less the amount of the carbon element and the amount of the nitrogen element is 0.005 times or more and 0.200 times or less the amount of the carbon element.

12. The electromagnetic wave absorber according to claim 9, further comprising
an insulating layer at an outermost surface on the electromagnetic wave incidence side.

13. A production method for an electromagnetic wave absorption material according to claim 1, comprising
a surface treatment step of treating surfaces of fibrous carbon nanostructures with plasma and/or ozone, to obtain surface-treated fibrous carbon nanostructures at surfaces of which an amount of an oxygen element is 0.030 times or more and 0.300 times or less an amount of a carbon element and/or an amount of a nitrogen element is 0.005 times or more and 0.200 times or less the amount of the carbon element.

14. A production method for an electromagnetic wave absorption material according to claim 1, comprising
a surface treatment step of treating surfaces of fibrous carbon nanostructures with plasma, to obtain surface-treated fibrous carbon nanostructures at surfaces of which an amount of a nitrogen element is 0.005 times or more and 0.200 times or less an amount of a carbon element.

15. A production method for an electromagnetic wave absorber, comprising:
a step of mixing surface-treated fibrous carbon nanostructures obtained in the surface treatment step according to claim 13 and an insulating material, to obtain a mixture; and
a step of shaping the mixture to obtain an electromagnetic wave absorber.

16. A production method for an electromagnetic wave absorber, comprising:
a step of mixing surface-treated fibrous carbon nanostructures obtained in the surface treatment step according to claim 14 and an insulating material, to obtain a mixture; and
a step of shaping the mixture to obtain an electromagnetic wave absorber.
